(19) United States
(12) Patent Application Publication
(10) Pub. No.: US 2019/0340564 A1
(43) Pub. Date: Nov. 7, 2019

(54) Monitoring Network Traffic to Determine Asset Utilization

(71) Applicant: WeWork Companies Inc., New York, NY (US)

(72) Inventors: Zachary Dean Holmquist, Salt Lake City, UT (US); Ron Ross, Salt Lake City, UT (US); Dal Adamson, Salt Lake City, UT (US); John Leland Pacific, Salt Lake City, UT (US)

(21) Appl. No.: 15/473,325

(22) Filed: Mar. 29, 2017

(51) Int. Cl. G06Q 10/06; H04L 12/26; G06Q 10/10

(52) U.S. Cl. CPC G06Q 10/063116; H04L 43/0876; G06Q 10/1095; H04L 43/065; H04L 43/045; H04L 43/062

(57) ABSTRACT

This disclosure describes, according to some implementations, a method that includes deploying a meter coupled to a private computer network. The meter captures packet data sent or received by network nodes coupled to the private computer network. Portions of the network nodes are associated with different physical spaces. The method further monitors activity of the network nodes in association with the different physical spaces based on the captured packet data, and determines, for a particular period of time, a utilization of a physical asset, which is located in a particular physical space of the different physical spaces, based on the monitored activity of a network node from the network nodes that represents the physical asset.

### BACKGROUND

The present disclosure relates to technology for, among other things, monitoring network traffic to determine asset utilization.

Many existing facility management systems are generally ineffective at determining whether the layout of a given building is effective and matches company effectiveness, cost, efficiency, or culture, and/or whether the technologies installed in that building facilitate employee effectiveness and/or are utilized sufficiently to justify their cost. In general, a complaint-drive, no-news-is-good-news approach is used by these solutions, replaces or eliminates problematic technologies based on complaints or service requests that are received. Further, when planning a meeting room, these solutions often rely on partial, inaccurate data that are not representative of the effectiveness, cost, efficiency, or culture of the company, and/or preferences of the employees/members to determine which technologies to install in that meeting room, such as video conferencing systems, whiteboards, digital assistants, meeting scheduling systems, projectors, computers, and other assets. As a result, the assets are often under or unutilized, and assets that are desired are often unavailable.

Additionally, these existing facility management systems are generally ineffective at determining, when configuring a facility, the number of rooms that are needed to accommodate a group of employees of different sizes. Generally, these solutions use a fixed ratio of employees to determine how many meeting rooms to plan for a given facility.

For instance, a company configured a facility for 556 employees, using an arbitrary, widely accepted ratio of 12 employees to 1 room, to have 46 rooms of varying size (17 small rooms accommodating 4 people, 16 medium rooms accommodating 9 people, 20 large rooms accommodate 20 people, and 1 large group room accommodating more than 20 people). The number of different sized rooms was largely determined using guesswork and not based on actual effectiveness, cost, efficiency, culture, or preference. Under a study conducted by Applicant, actual use demonstrated that the employees needed small and medium-sized rooms, and thus underutilized the large rooms by conducting small meetings in those rooms, which to the perception by the employees that the facility was not large enough to handle their needs.

Even more, these solutions are unable to dynamically suggest, or learn over time, an optimal space and/or asset plan. Organizations lose a significant amount of employee productivity year-to-year due to space underutilization and poor performing and/or non-existent in-room technologies. They are also unable to automatically generate and provide actionable insights to stakeholders on planning and asset utilization.

### SUMMARY

The systems, methods, apparatuses, and other aspects described by this specification overcome the deficiencies and limitations of the solutions described in the Background. According to one innovative aspect of the subject matter described in this disclosure, one such method includes deploying a meter coupled to a private computer network. The meter captures packet data sent or received by network nodes coupled to the private computer network. Portions of the network nodes may be associated with different physical spaces. The method further monitors activity of the network nodes in association with the different physical spaces based on the captured packet data; and determines, for a particular period of time, a utilization of a physical asset, which is located in a particular physical space of the different physical spaces, based on the monitored activity of a network node from the network nodes that represents the physical asset.

The method and/or other implementations may each optionally include one or more of the following features: grouping, at the meter, the captured packet data according to the different physical spaces in which the network nodes that sent or received the packet data are located, that monitoring activity of the network nodes is further based on different groups with which the captured packet data are associated; that the different groups represent the different physical spaces in which the network nodes are associated; retrieving packet data reflecting the activity of the network nodes sending or receiving data during the particular period of time and associated with the particular physical space; that the particular period of time reflects a meeting conducted in the particular physical space; generating a graphical meeting data visualization showing an asset topology for the particular physical space using the packet data reflecting activity of the network nodes during the particular period of time; displaying, on a display device to a stakeholder, the graphical meeting data visualization in a graphical user interface; receiving, via an input device coupled to the display device, an input associated with a topological element of the graphical meeting data visualization; retrieving packet data underlying the topological element; displaying a graphical element providing a description of the topological element in association with the topological element; the graphical element is an overlay overlaid over the topological element in the graphical user interface; monitoring presence in the particular physical space based on motion packet data received from one or more motion sensors associated with the particular physical space; that the motion packet data describe motion by one or more people located in the particular physical space; that the captured packet data include the motion packet data; that the network nodes include the one or more motion sensors; that the particular period of time reflects a meeting conducted in the particular physical space; determining one or more of an actual start time and an actual end time of the meeting conducted in the particular physical space based on the motion packet data; processing the motion packet data received during the particular period of time to determine a number of people located in the particular physical space over the particular period of time and any change in the number of people in the particular physical space over the particular period of time; determining an attendance profile for the meeting using the number of people and the change in the number of people processed from the motion data; performing a comparison between the actual start time and the actual end time of the meeting to a scheduled meeting duration associated with a stored meeting entry; and determining a meeting efficiency score for the meeting based on the comparison.

In general, another innovative aspect of this subject matter described in this disclosure may be embodied in a data packet processing meter that comprises: one or more computer processors; one or more non-transitory memories; a communication unit that sends and receives data via a private computer network; a network data processor executable by the computer processors to capture packet data sent or received by network nodes coupled to the private computer network; a utilization monitor; and a utilization logger. Portions of the network nodes are associated with different physical spaces. The utilization monitor is executable by the computer processors to monitor activity of the network nodes in association with the different physical spaces based on the captured packet data. The utilization logger is executable by the one or more computer processors to log packet data reflecting the monitored activity of the network nodes by transmitting the packet data to a facility asset utilization monitor that determines, for a particular period of time based on the packet data, a utilization of a physical asset, which is located in a particular physical space of the different physical spaces, based on the monitored activity of a network node that represents the physical asset.

The meter and/or other implementations, may optionally include an asset filter executable by the one or more computer processors to group the captured packet data according to the different physical spaces in which the network nodes that sent or received the packet data are located. The facility asset utilization monitor receives the captured packet data from one of the asset filter and the one or more non-transitory memories. The facility asset utilization monitor monitors activity of the network nodes further based on different groups with which the captured packet data are associated. The different groups represent the different physical spaces in which the network nodes are associated.

In general, another innovative aspect of this subject matter described in this disclosure may be embodied in methods including: deploying a meter in association with a gateway of a private computer network; that the meter captures packet data sent or received by network nodes coupled to the private computer network and located behind the gateway of the private computer network; that a first portion of the network nodes is installed in association with a first physical space within a premises; that a second portion of the network nodes is installed in association with a second physical space within the premises; capturing, at the meter, packet data exchanged by network nodes; grouping, at the meter, the captured packet data received from the first portion of the network nodes with a first identifier uniquely identifying the first physical space; grouping, at the meter, the captured packet data received from the second portion of the network nodes with a second identifier uniquely identifying the second physical space; monitoring, at the meter, activity of the network nodes of the first portion in association with the first physical space based on the first portion of network nodes being grouped with the first identifier, and activity of the network nodes of the second portion in association with the second physical space based on the second portion of network nodes being grouped with the second identifier; logging, at a utilization server, the activity of the first portion of network nodes and the activity of the second portion of the network nodes.

The method and/or other implementations may each optionally include one or more of the following features: processing the activity of the first portion of the network nodes and the activity of the second portion of the network nodes to determine a utilization profile of the first physical space and a utilization profile of the second physical space; and generating a utilization recommendations for a stakeholder associated with the premises based on the utilization profile of the first physical space and the utilization profile of the second physical space.

In general, another innovative aspect of this subject matter described in this disclosure may be embodied in systems including: one or more computer processors; one or more non-transitory memories storing instructions that, when executed by the one or more computer processors, cause the computing system to perform operations comprising: deploying a meter coupled to a private computer network. The meter captures packet data sent or received by network nodes coupled to the private computer network. Portions of the network nodes are associated with different physical spaces. The operations further comprise: monitoring activity of the network nodes in association with the different physical spaces based on the captured packet data; and determining, for a particular period of time, a utilization of a physical asset, which is located in a particular physical space of the different physical spaces, based on the monitored activity of a network node that represents the physical asset.

The systems and/or other implementations may each optionally include one or more of the following features: grouping, at the meter, the captured packet data according to the different physical spaces in which the network nodes that sent or received the packet data are located; that monitoring activity of the network nodes is further based on different groups with which the captured packet data are associated; that the different groups representing the different physical spaces in which the network nodes are associated; retrieving packet data reflecting the activity of the network nodes sending or receiving data during the particular period of time and associated with the particular physical space; that the particular period of time reflects a meeting conducted in the particular physical space; generating a graphical meeting data visualization showing an asset topology for the particular physical space using the packet data reflecting activity of the network nodes during the particular period of time; displaying the graphical meeting data visualization in a graphical user interface; receiving an input associated with a topological element of the graphical meeting data visualization; retrieving packet data underlying the topological element; displaying a graphical element providing a description of the topological element in association with the topological element; that the graphical element is an overlay overlaid over the topological element in the graphical user interface; monitoring presence in the particular physical space based on motion packet data received from one or more motion sensors associated with the particular physical space; that the motion packet data describing motion by one or more people located in the particular physical space; that the captured packet data including the motion packet data; that the network nodes include the one or more motion sensors; that the particular period of time reflecting a meeting conducted in the particular physical space; determining one or more of an actual start time and an actual end time of the meeting conducted in the particular physical space based on the motion packet data; processing the motion packet data received during the particular period of time to determine a number of people located in the particular physical space over the particular period of time and any change in the number of people in the particular physical space over the particular period of time; determining an attendance profile for the meeting using the number of people and the change in the number of people processed from the motion data; performing a comparison between the actual start time and the actual end time of the meeting to a scheduled meeting duration associated with a stored meeting entry; and determining a meeting efficiency score for the meeting based on the comparison.

Other aspects include corresponding methods, systems, apparatus, and computer program products for these and other innovative aspects.

The technology disclosed herein is particularly advantageous in a number of respects. For instance, the technology can automatically aggregate network data traffic and determine, based on the traffic, which assets are being utilized, whether meetings are being efficiently conducted, whether a current layout for a facility meets company effectiveness, cost, efficiency, culture, and/or preferences, and/or how to plan for future infrastructure. It should be understood that the foregoing advantages are provided by way of example and that the technology may have numerous other advantages and benefits. Further, it should be understood that the Summary describes various example aspects of the subject matter of this disclosure and is not intended to encompass every inventive aspect.

### BRIEF DESCRIPTION OF THE DRAWINGS

The specification is illustrated by way of example, and not by way of limitation in the figures of the accompanying drawings in which like reference numerals are used to refer to similar elements.

FIG. 1 is a block diagram of an example asset utilization monitoring system.

FIG. 2 is a block diagram of an example asset utilization monitoring configuration.

FIG. 3 is a block diagram of example physical space layouts.

FIGS. 4A and 4B portray example activity data processed by a meter.

FIG. 5A portrays an example asset topology.

FIG. 5B portrays an example meeting profile.

FIG. 5C portrays another example asset topology.

FIG. 6 is a flowchart of an example method for determining utilization of physical asset based on monitored network node activity.

FIG. 7A is a flowchart of an example method for capturing and grouping packet data associated with different physical spaces.

FIG. 7B is a flowchart of an example method for generating an asset topology.

FIG. 8 is a flowchart of an example method for processing topology-related input.

FIG. 9 is a flowchart of an example method for monitoring meeting presence and determining meeting efficiency.

FIG. 10 is a flowchart of an example method for analyzing network data to determine a space plan.

FIG. 11 is a block diagram of an example computing system.

FIG. 12 is a graphical representation of a graphical user interface providing a utilization overview.

FIG. 13 is a graphical representation of a graphical user interface providing an amenity overview.

FIG. 14 is a graphical representation of a graphical user interface providing a detailed amenity view.

### DETAILED DESCRIPTION

The technology disclosed in this application can, for a given organization, automatically aggregate network data traffic and determine, based on the traffic, which assets are being utilized, whether meetings are being efficiently conducted, whether a current layout for a facility is effective, whether infrastructure meets company effectiveness, cost, efficiency, culture, etc., and/or how to plan for future infrastructure.

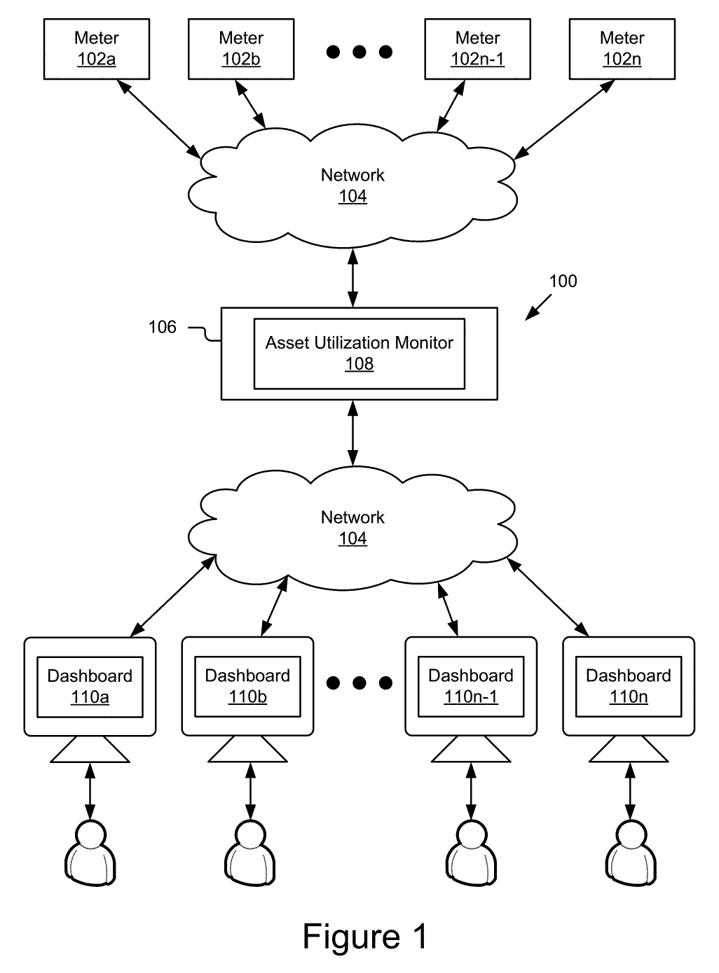

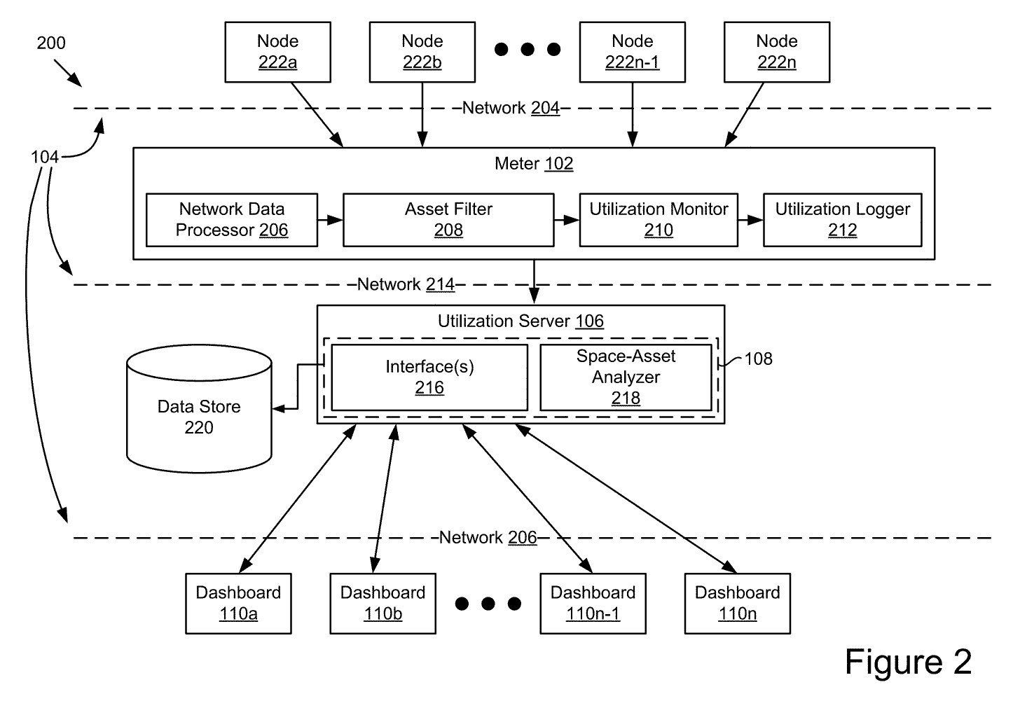

The technology may include an example asset utilization system, such as the example system 100 shown in FIG. 1. The system 100 may, in some implementations, may provide monitoring of computer network data traffic, accurate determination of the identities and attributes of the nodes 222 (e.g., see FIG. 2) sending or receiving (communicating) the network data traffic, and associating that traffic with physical space. Each physical space may be embodied by an entry in the data store 220 (e.g., see FIG. 2), which may include data describing the physical space and an index. For instance the entry may include a unique identifier for the physical space, a description of the physical location, a physical address for the space, a size, etc.

Meetings may be held in the physical spaces. In some instances, meetings may be scheduled or impromptu. In some implementations, a meeting may be embodied by an entry in a data store specifying a meeting id, time, physical space id, medium, and/or attendee identifiers of the corresponding attendees of the meeting as applicable. A meeting and the meeting entry may be used interchangeably in this document for convenience in some cases. In some cases, the meeting entry may reflect a digital calendar entry for a scheduled meeting in a particular physical space, an impromptu meeting, or an unscheduled meeting. The meeting medium may be a physical space (e.g., a conference room, etc.) and include virtual options for remote attendees (e.g., a phone number, online meeting, video conference, etc.). An attendee may describe a person invited to a meeting (prospective attendee) or a person that was present at the meeting. In some implementations, an attendee may be referred to as an invitee when the attendee has been invited to a meeting but has not yet attended. Attributes of each attendee may be stored and maintained in a user profile unique to that attendee, as discussed in further detail below. A user identifier may be a user id or handle, an e-mail, a unique number, or another unique identifier.

As depicted, the system 100 may include one or more meters 102a . . . 102n (also referred to herein individually or collectively as 102), a network 104, a utilization server 106 including an asset utilization monitor 108, and a plurality of dashboards 108a . . . 108n (also referred to herein individually or collectively as 108). A meter may be executable to monitor nodes 222.

A premises, also referred to as a facility, includes one or more physical gathering places in which people congregate for a particular purpose. A premises may represent a campus, building(s), pavilion(s), or other structures that is associated with a stakeholder. The stakeholder may be an entity, such as a business or other organization. A premises includes one or more designated physical spaces, such as meeting rooms, in which people congregate for a particular purpose, such as but not limited to a work meeting.

A node 222 is representative of a physical asset installed in a premises and associated with one or more physical spaces within that premises. In a typical arrangement, a physical space, such as a meeting room, includes a plurality of physical assets available for use by the people present in the physical space and/or to monitor the activity in the physical space. A node 222 may be associated in the data store 220 with one or more particular physical spaces.

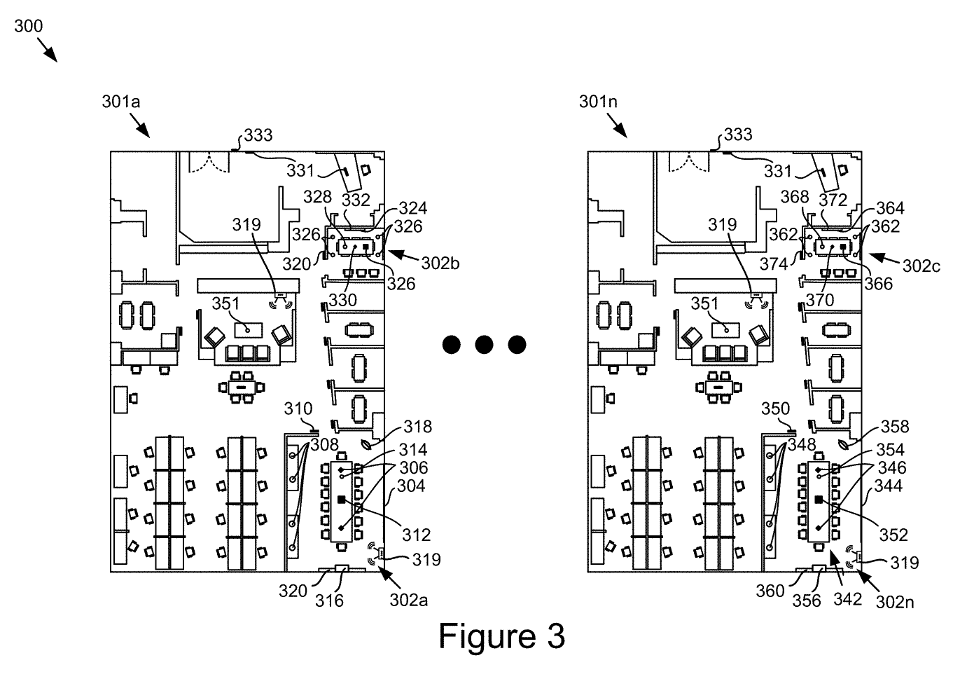

A given meter 102 may capture network data sent and received by the node 222 being metered by the meter 102, and activity by the node 222 may be processed and logged by the meter 102 in association with the physical space(s) it is associated with. For instance, during operation and in association with a given physical space, the node 222 can communicate data via the network 104 to/from other endpoints of the network 104. The meter 102 may capture the data while en route, and process it as discussed in further detail herein. Example nodes are discussed in detail below, for instance, with reference to FIG. 3.

One or more meter(s) 102 may be installed by a stakeholder in the premises to monitor the network data sent or received by the nodes 222. A meter 102 may automatically discover new nodes 222 that are added to a portion of the network 104 monitored by the meter 102, and upon being discovered, may automatically identify the type of assets represented by the nodes 222, and may determine the particular physical space(s) in which the nodes 222 are associated. In some implementations, a dashboard 110 may prompt a user (stakeholder representative) to confirm the identities of the discovered node(s) and/or the physical space(s) with which the asset(s) represented by the discovered node(s) 222 are associated. Upon receiving input confirming such, the dashboard 110 may transmit a response including the input to the asset utilization monitor 108, which may store the data in the data store 220.

A meter 102 may be coupled to the asset utilization monitor 108 via the network 104 to provide information about the activity of the node(s) 222 metered by the meter 102.

The asset utilization monitor 108 may receive data from a plurality of meters 102a . . . 102n associated with various stakeholders, and group, process, and/or aggregate the information for presentation on a plurality dashboards 108a . . . 108n for viewing by users representing the stakeholders. In some implementations, the data may be aggregated from the meter(s) 102 in real-time, which means that the data may be metered, collected, analyzed immediately, or may be transmitted upon request or at other suitable intervals (regular, irregular, etc.).

Client devices are computing devices having data processing and communication capabilities. In some embodiments, a client device may include a processor (e.g., virtual, physical, etc.), a memory, a power source, a communication unit, and/or other software and/or hardware components, such as a display, graphics processor, wireless transceivers, keyboard, camera, sensors, firmware, operating systems, drivers, various physical connection interfaces (e.g., USB, HDMI, etc.). Client devices may couple to and communicate with one another and the other entities of the system 100 via the network 104 using a wireless and/or wired connection. Example client devices may include, but are not limited to, mobile phones, tablets, laptops, desktops, netbooks, server appliances, servers, virtual machines, TVs, set-top boxes, media streaming devices, portable media players, navigation devices, personal digital assistants, on-wall and/or table touchscreen displays, etc. The system 100 may include any number of client devices (e.g., hosting any number of dashboards 110). In addition, the client devices may be the same or different types of computing devices.

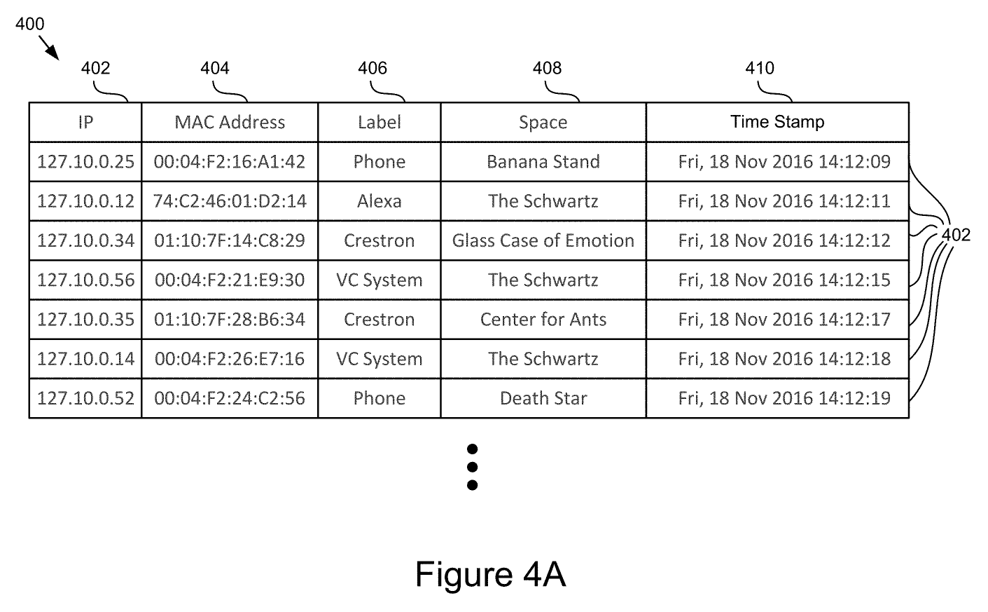

The structure, acts, operation, and/or functionality of the components of the system 100, are described in more detail below. The dashboards instances 110 (e.g., 110a, 110b, 110n−1, 110n) are presented on client devices so users may review utilization data, meeting statistics, meeting topologies, space plans, and other information. Non-limiting examples of user interfaces and/or interface components that may be rendered and displayed by a given dashboard 110 are illustrated in FIGS. 4A-5C, and 12-14.

FIG. 2 is a block diagram of an example asset utilization monitoring configuration 200, which is depicted as including one or more nodes 222 (e.g., 222a, 222b, 222n−1, . . . 222n), one or more meter(s) 102, a utilization server 106, and one or more dashboard instances 110a, 110b, 110n−1, . . . 110n (also simply referred to individually or collectively as 110) coupled for communication by the network 104, which may include networks 204 and 214, among other suitable networks.

The network 204 can be a controlled network in which access may be monitored for unauthorized activity under the direction of a stakeholder, such as a business. For example, the network 204 may include security infrastructure, such as a firewall, gateway, etc., that can monitor and control access to and/or within the network 204. The meter 102 may be coupled to communicate with the node(s) 222 and/or other components, such as the security infrastructure, and may send data to and/or receive data from these components. As an example, the network 204 may include virtual and/or physical private network(s) (e.g., LAN, VPN, EPN, CAN, etc.) via which the meter(s) 102 and node(s) 222 communicate, although any network in which access may be monitored is contemplated and applicable.

A meter 102 may capture/collect network data sent to and/or from the node(s) 222 via the network 204 directly or via an intervening component, such as a component regulating data communicated on the network 204 (e.g., a firewall operating on the same computing system and/or a different computing system coupled for communication via the network 204. The network data may include packet data send to and/or received by the node(s), although any suitable data transmitted between network components is applicable.

The packet data may include the packets sent and/or received by a node 222, or may include data derived from the packets. Data may be derived from the packet(s), in some cases, by another network-connected component, such as the component(s) that monitor activity on the network 204. A given packet may include a header and a payload, as is standard in modern digital network communications, and may be transmitted in a communication session between system 100 components, although any suitable data unit including information identifying the sender, receiver, and the data being transmitted, is contemplated and encompassed by this disclosure. In a further example, packet data may include the packet and/or any data processed from the header and/or payload of the packet. Further non-limiting example network traffic data may include a source IP address(es), source protocol(s), port number(s), destination IP address(es), destination protocol(s), destination port(s), round-trip time (RTT) metrics, TCP flow metrics, latency, transmission timestamps, payload data, encryption data, etc.

A meter 102 can process the network data to associate the node(s) 222 communicating the network data with assets located in various physical spaces of the stakeholder, as discussed in further detail below. A meter 102 may be operable as a software agent to capture the network data. A meter 102 may be operable on a dedicated computing system, a gateway, a computing device including network control software and/or hardware, such as a firewall, a virtual computing system hosted by a physical computing system, a cloud computing platform, a hybrid IT infrastructure including cloud-based and local computing assets, etc., and may collect information about the operations of the node(s) 222, such as their performance, activity, identity, etc.

The data collected/captured and processed by the meters 102, such as the information discussed in detail herein, may be captured upon transmission (in real time, near real time), although it should be understood that the meters 102 can collect the information at various other intervals, such as at various time intervals from intervening components of the system 100. The meter 102 may relay the data collected and processed by it to the asset utilization monitor 108 for further analysis, storage, and/or provision to users 112a as dashboard data.

A meter 102 may include a network data processor 206, an asset filter 208, a utilization monitor, and a utilization logger 212.

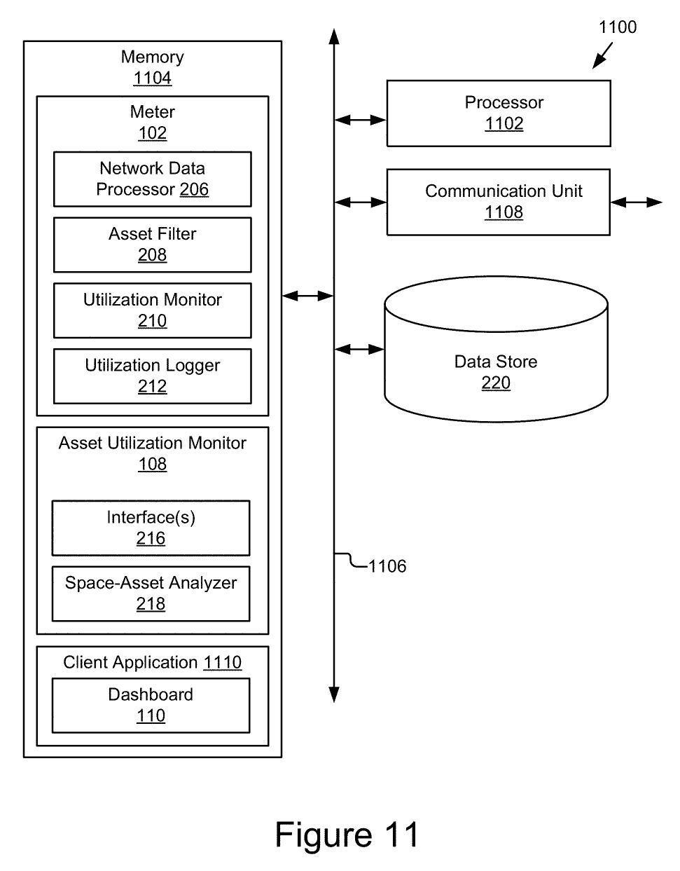

The network data processor 206 includes computer logic executable by a computing system (e.g., computing system 1100 in FIG. 11) to capture network data sent or received by network nodes coupled to a controlled computer network. In various implementations, the network data processor 206 may receive the network data from the node(s) 222 metered by the meter 102, or from an intervening network component that monitors and/or pre-processes the data received from the node(s) 222. The network data processor 206 may parse the network data to determine its source, destination, device information, payload, timestamp, and other aspects. The network data processor 206 may provide the sets of data processed by it to the asset filter 208 and/or other components of the meter 102, and/or may store the processed sets of network data processed by it in non-transitory memory (e.g., memory 1104 in FIG. 11).

The asset filter 208 includes computer logic executable by a computing system 1100 to associate the network data with particular physical assets and/or particular physical spaces. The asset filter 208 may be coupled to the network data processor 206 and/or the non-transitory memory 1104 to receive processed network data.

In some implementations, the asset filter 208 may receive sets of parsed data, and may process each set and associate it with a given node 222, which represents a physical asset installed in associate with a physical space. The memory 1104 may store an asset database correlating assets with the physical spaces with which they are associated, and the asset filter 208 may query the database using a node identifier included in a set of parsed data (e.g., IP address, device ID, other suitable identifier, etc.) and retrieve data describing the type of device that the node 222 is, and/or the physical space that the node 222 is located in and/or associated with. In some implementations, the asset filter 208 may flag node(s) 222 that it is unable to classify into a device type and/or associate with a particular physical space, and may store data flagging the unclassified and/or unassociated node 222 in the asset database in association with database entry(ies) representing the node 222. In some implementations, the asset filter 208 may filter-out any network traffic that was communicated by nodes unrelated to the physical space(s) of a given premises, and may use (retrieve, update, etc.) a blacklist stored in the memory 1104 to identify a given network endpoint as unrelated and filter it out from further processing.

The utilization monitor 210 includes computer logic executable by a computing system 1100 to determine activity details, such as the time of the transmission of a given set of network data and/or classify the purpose of the payload of the set. In some cases, the utilization monitor 210 may parse the payload to search for identifiable keywords, codes, text strings, etc., that are known and/or can be used to train a suitable machine learning algorithm for future identification. Various classifications into which the purpose may be categorized may include an error, a protocol (e.g., VOIP, TCP/IP, WebSocket, RTP, RTSP, HTTP(S), SSH, etc.), an API call, a command, etc. In some cases, the utilization monitor 210 may process and/or interpret motion data from the sets of data provide by the network data processor 206, as discussed elsewhere herein.

The utilization logger 212 includes computer logic executable by a computing system 1100 to log the data processed by the network data processor 206, the asset filter 208, and/or the utilization monitor 210. The utilization logger 212 may log this data in the data store 220 or another suitable non-transitory storage device. In some implementations, the utilization logger 212 may access an application programming interface surfaced by the asset utilization monitor 108 to store the data in the data store 220, may access the data store 220 more directly using a suitable application interface and/or procedure calls, etc., and/or using other suitable methods.

The network 214 may include one or more public networks (e.g., wide area networks (WANs) and/or other public infrastructure) (e.g., the Internet) over which devices may communicate. The meter 102 may communicate with the utilization server 106, and vice versa, via the network 214.

The space-asset analyzer 218 includes computer logic executable by a computing system 1100 to analyze the data aggregated from the meter(s) 102 and compute novel analytics, such as attendance profiles, asset topologies, space plans, utilization profiles, asset and/or space recommendations and reconfigurations, etc., as discussed elsewhere herein.

An asset topology is a data visualization that describes asset utilization across one or more dimensions. A dimension may include, but is not limited to, a meeting, a group of meetings, an organization, a group within an organization, an individual within an organization, etc.

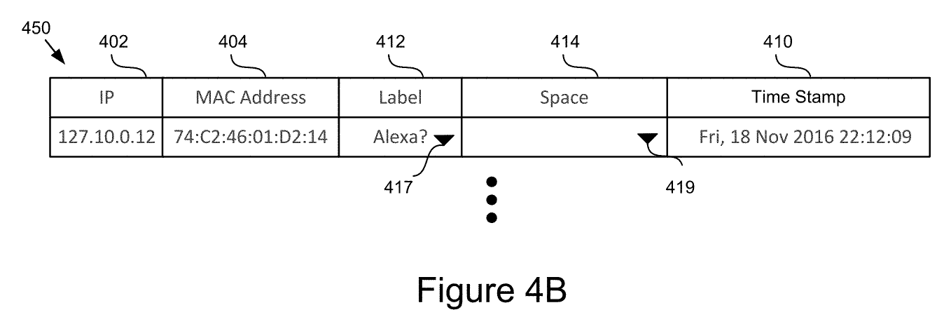

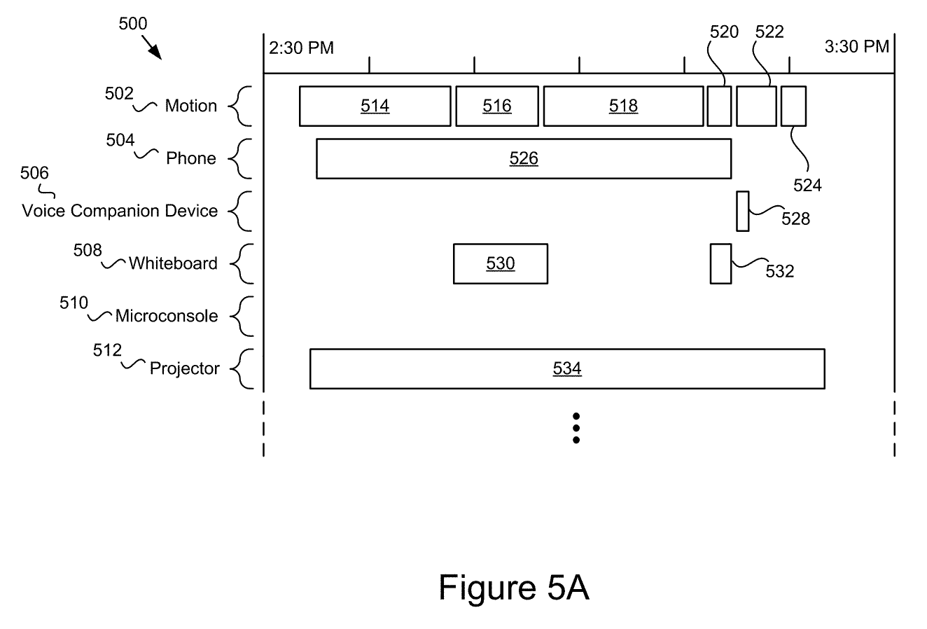

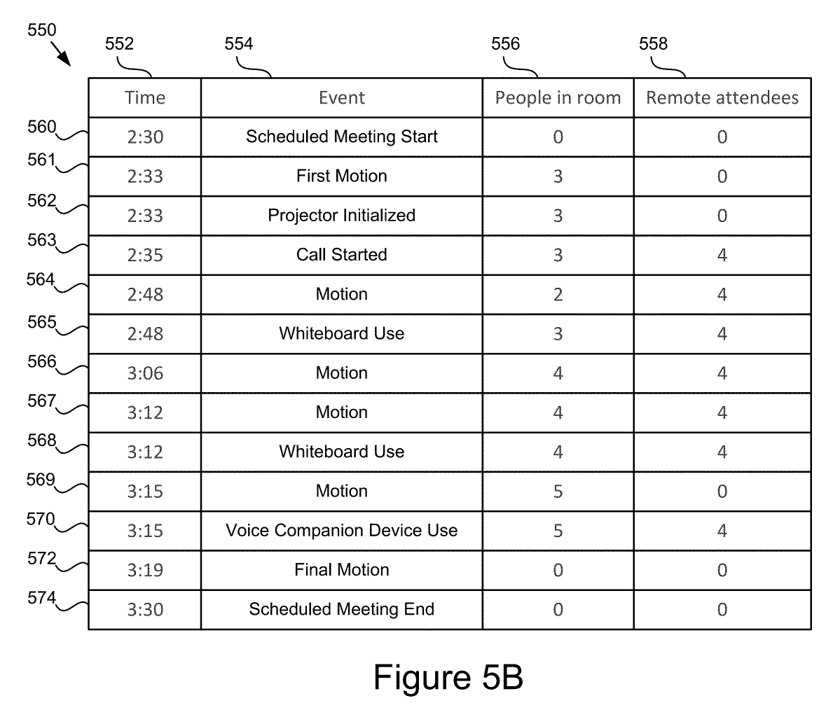

FIGS. 5A and 5C portrays example asset topologies 500 and 575, and FIG. 5B portrays an example utilization data set 550 corresponding the asset topology 500. In particular, the asset topology 500 depicted in FIG. 5A, includes a first dimension 501 describing different types of devices (e.g. nodes 222) present in a particular physical space, and a second dimension 503, which is a timeline. The first dimension 501, as shown, includes rows for several devices in the physical space, such as a set of one or more motion devices 502, a phone system 504, a voice companion device 506, a whiteboard 508, a micro-console 510, and a projector 512, among other assets. For each device, utilization indicators (e.g., 514, 516, 518, etc.) are displayed in the asset topology 500 to show if/when each device was active over the timeline 503. For example, for the set of motion devices 502, utilization indicators 514, 516, 518, 520, 522, and 524 span the timeline to show that motion was detected in the physical space relatively continuously from about 2:33 PM to about 3:22 PM, showing that the meeting that occurred from 2:30 PM to 3:30 PM actually began a little late and ended early based on the motion data received from the motion devices 502.

For the phone 504, the utilization indicator 526 shows that network data (e.g., VoIP packets) were continuously transmitted by the phone 504 from about 2:35 PM to 3:14 PM, showing that the meeting and the physical space continued a little bit beyond the phone call, which may have conferenced in remote attendees.

For the voice companion device 506, the utilization indicator 528 shows that the voice companion device was likely used one time during the meeting in the physical space at approximately 3:15 PM.

In some cases, nodes 222, such as the voice companion device 506, may transmit data at regular intervals to simply check in with the management server. The asset-space analyzer 218 may identify these trends by analyzing the data received from a given node 222. For example, a node 222 may a ping a management server, or send a regular requests to the management server, and the asset-space analyzer 218 and identify the transmission as a check-in. For example, the asset-space analyzer 218 may compare a recently received data packet to previously received data packets and determine that the payload is substantially the same, may parse the header and are payload to determine the purpose of the data packet (e.g., that it is a ping or other type of check-in request), etc., and may determine that these types of transmissions to not reflect actual use of the node 222 transmitting it.

For instance, a check-in, or other regular transmission, that is not related to actual use of the node 222, may be labeled as non-substantive by the asset-space analyzer 218, and the label may be stored in the data store 222 in association with activity data embodying the transmission supposed to flag the transmission as non-substantive. The asset topology may be generated to exclude these non-substantive transmissions to eliminate noise from the topology. In some implementations, the asset apology may include an option to show and/or hide these non-substantive transmissions, and a user, using an input device, may select the graphical user interface option to show or hide the utilization indicators reflecting the transmissions.

In some implementations, the asset-space analyzer 218 may compare the timing of a series of data packets received from a node 222, and if the data packets are captured and/or transmitted at a fixed periodicity (the amount of time between transmission of the data packets is the same or substantially the same (e.g., within 95%+), the asset-space analyzer 218 may determine that the transmission is non-substantive but rather programmatic in nature, and thus is does reflect actual node activity (reflecting sensor input, device feature or tool utilization, etc.).

In some implementations, the asset-space analyzer 218 may identify, using activity data, that a data transmission by a node 222 was reporting an error to another node on the network 104, such as a management server. As a result, the transmission may be excluded from the asset topology to allow for display of node activity triggered by a user movement and/or user asset utilization. In further implementations, utilization indicators may be included for error transmissions, with an option to hide the error transmissions and/or show the error transmissions as described previously.

In some implementations, a given node 222 may have a particular historical utilization rate (daily, weekly, etc.). For instance, the node 222 may historically regularly (e.g., several times a day, each day, etc.) transmit check-in requests to a management server, may historically regularly pull configuration data from a management server, may historically regularly push state information to a management server, may historically regularly submit content requests to content servers (e.g., weather information, news, social streams, calendar updates, etc.) and receive content responsive to those requests, etc. The data reflecting these request may be stored in the data store 220, and the space-asset analyzer 218 may compare current and/or recent activity (e.g., past day, past hour(s), etc.) to historical utilization to determine whether any deviation exists, and whether that deviation is sufficient enough to determine that the asset may be experiencing operation issues. For example, if a node 222, that typically is utilized between 10-15% every day has experienced no activity for the past 24 hours, the space-asset analyzer 218 may flag the asset as offline and trigger a service request. In some instances, the space-asset analyzer 218 may generate and send a notification to the dashboard 110 of the client device of a user determined to be located in a room in which the node 222 resides and may request feedback from the user via an interface presenting the notification, such as an indication whether the device is off-line or behaving normally. The user may input the feedback via the interface (e.g., singly select an interface button indicating node 222 “operating normally” or node 222 “experiencing issues,” and the client device may generate and send a response via an interface 216 to the space-asset analyzer 218 providing the feedback, which the space-analyzer 218 may process accordingly (e.g., trigger a service request to fix the problematic node 222), store data flagging the lowered usage as an anomaly and/or adjusting the historically utilization rate accordingly, etc.

The timeline 503 may be user adjustable by selecting on the timeline using input device (e.g., touchscreen, pointing device, microphone via a voice command, etc.), or a dedicated element, such as a button for setting the timeline to a particular range. Upon adjusting the timeline, the dashboard 110 may retrieve utilization data for each device that corresponds to the adjusted range and may update the asset topology 500 accordingly.

For the whiteboard 508, the utilization indicators 530 and 532 reflect the usage of the whiteboard during a meeting from about 2:48 PM to 2:56 PM, and 3:12 PM to 3:14 PM, respectively. Activity on the whiteboard may be detected using one or more motion sensors directorate capturing movement occurring in proximity to the whiteboard and associated with the whiteboard in the data store 220, embedded sensors in the whiteboard detecting writing activity occurring on the whiteboard, or other suitable methods.

In some further implementations, the whiteboard 508 can include an interactive whiteboard, such the virtual workspace product provided by Bluescape™, or other applicable electronic whiteboard, that is coupled to the network 104 to exchange network data with a remote server via the system 100, and whose network traffic can be metered as discussed elsewhere herein.

For the microcontroller 510, no network data was captured by the meter 102, and as a result no utilization indicators are included in the asset topology 500, reflecting that the microconsole was not used. Examples of microconsoles include set-top devices that are coupled to displays (e.g., large format displays hung on a wall or placed on a table) to mirror a desktop of a computing device (e.g., laptop), play video from a media server, play music, along with other functionalities. This can reflect to the user that that particular asset is underutilized.

For the projector 512, network data was captured for about the same duration as motion data was, reflecting further that the actual start time of the meeting occurred later than planned and ended earlier than planned. For example, the asset-space analyzer 218 may compare multiple data points from different nodes 222 to increase the confidence that the meeting ended and/or started at a particular points in time. In addition to visually displaying this information in the asset topology, this information, as well as any other findings discussed herein, can be incorporated into a utilization profile and/or recommendations provided by asset utilization monitor 108 and/or displayed in dashboards 110.

In contrast to FIG. 5A, the asset topology depicted in FIG. 5C is for a meeting occurring in the same timeframe as in asset topology 500. The space in which the meeting occurred includes a different mix of devices than those in FIG. 5A. This mix of devices include a set of motion devices 576, a phone 578, a voice companion device 580, a whiteboard 582, a micro-console 584, a projector 586, and a TV 588. As shown, no substantive network data was captured by the meter 102 for the devices 578, 580, and 586. Over time, if no substantive network data is received from the nodes 222 representing these devices, the asset-space analyzer 218 may label the devices as underutilized in the data store 220 by storing a flag indicating such in association with an entry embodying the node 222 in the data store 220. The asset-space analyzer 218 may then provide the utilization data to the stakeholders described elsewhere herein.

Additionally, as shown by the utilization indicators 592, 594, and 596, collectively, and 598, and 599, the meeting actually started around 2:36 PM and ended about 20 minutes earlier than the designated end time of 3:30 PM, which shows there was a significant utilization loss. In cases where the attendees of this meeting, which may be a recurring meeting, the asset topology could include a recommendation to schedule the meeting for a half an hour block or 40 minute block, instead of for the full hour.

Typical scheduling habits reflect that meetings are often scheduled in half-hour blocks. However, by dynamically analyzing the activity data, the asset-space analyzer 218 can advantageously identify when meeting should be shortened or lengthened relative to their scheduled time, and suggest such to the organizer via a messaging medium and/or a graphical user interface presented by the dashboard 110.

For the whiteboard 582, the asset topology 575 includes a utilization indicator 597 reflecting that the whiteboard was used once a particular time during the meeting.

FIG. 5B portrays an example meeting profile 550. The meeting profile 550, includes a plurality of rows 560-574, and a plurality of columns 552, 554, 556, 558, although should be understood that additional or fewer rows to be included, as well as columns or additional and/or alternative data. As shown, the meeting profile 550 reflects the activity depicted in the asset topology 550 of FIG. 5A.

The asset-space analyzer 218, for a particular instance of network data, may label that activity based on the type of device that transmitted the instance of network data and/or a meeting entry stored in the data store. For instance, the meeting entry may reflect that the meeting was scheduled to start at 2:30 PM, however a motion device detected that motion did not occur in the meeting room until 2:33 PM, which the asset-space analyzer identified as “first motion.” Based on the presence data received, the space-asset analyzer 218 identified, using a motion data and standard object detection algorithms, that the three person-like objects were detected in the motion data with sufficient confidence (e.g., 75%+, although other suitable thresholds are contemplated). As such, space-asset analyzer 218 stored in the data store 220 reflecting that at 2:33 PM, three people were in the room. Similar determinations at different points in time are made in rows 562-574, although in rows 572 and 574, the objects were detected in the motion data with sufficient confidence to determine that there were people in the room, which reflects that the meeting ended around 3:22 PM, as shown in row 572, which is 11 minutes prior to the scheduled meeting end-time as shown in row 574.

Column 558 shows the number of remote attendees that attended the meeting, such as via telephone and/or videoconference. Data reflecting the number of people that remotely attended the meeting may be aggregated from a phone management server, web-share hosting server, or video management server (which may be first or third party servers coupled to the network 104 and having computing architectures similar to that depicted in FIG. 11), as applicable, and stored and correlated with the meeting data (e.g., meeting entry, activity data, etc.).

The space-asset analyzer 218 may be coupled to the data store 220 and/or the interface(s) 216 to retrieve and/or receive data for analysis, may store data analyzed by it in the data store 220, and/or may provide the analyzed data to an interface 216 for formatting and/or transmission to a dashboard 110.

In some implementations, the asset-space analyzer 218 may process the activity of the nodes 222 in the various physical spaces of a premises of a given stakeholder and generate utilization recommendations based on the processing. For instance, with reference to an example involving two or more spaces (e.g., first, second, etc.) of a premises, the asset-space analyzer 218 may process the activity of a first portion of the network nodes 222, which are associated with a first physical space, and may process the activity of a second portion of the network nodes 222, which are associated with a second physical space, to determine a utilization profile of the first physical space and a utilization profile of the second physical space. The asset-space analyzer 218 may generate utilization recommendation(s) for the stakeholder associated with the premises based on the utilization profile of the first physical space and the utilization profile of the second physical space.

In some implementations, the meter 102 may determine one or more of an actual start time and an actual end time of the meeting conducted in the particular physical space based on the motion packet data, and that data may be stored in the data store 222 as activity data for processing by the asset-space analyzer 218, as discussed elsewhere herein. For instance, the asset-space analyzer 218 may process the motion packet data received during the particular period of time to determine the number of people located in the particular physical space over the particular period of time and any change in the number of people in the particular physical space over the particular period of time. The asset-space analyzer 218 may determine an attendance profile for the meeting using the number of people and the change in the number of people processed from the motion data. For instance, as shown in FIG. 5C, the meeting profile includes an attendance profile in column 556 shows that the number of people in the room during the meeting fluctuated between 0-5.

The interface(s) 216 includes computer logic executable by a computing system 1100 to provide access to utilization data and/or other data processed by the meter(s) 102 and/or the space-asset analyzer 218. In some implementations, an interface 216 may be an API, an object broker, a web server (e.g., an HTTP server, a REST (representational state transfer) service), a remote procedure call server, or other suitable server type capable of receive and satisfying content request, etc. An interface 216 may format data based on its type. For instance, an interface may 216 generate and format utilization and/or other data processed by the system 100 into structured data, such as HTML, XML, JSON, etc., although other suitable data formats are also contemplated. In some implementations, an interface 216 may receive a storage and/or analysis request from the utilization logger 212 including data processed by the meter 102, and the interface 216 may receive the processed data and store it in the data store 212 and/or provide it to the space-asset analyzer 218.

An interface 216 may provide utilization and/or other data (dashboard data) to the dashboards 110 and may perform user authentication to ensure proper, secure access to the dashboard data. One advantage of the dashboard 110 is that it can transform the data being collected, grouped, organized, and/or analyzed by the system 110 into visually and graphically rich data visualization and other content, and provide them to users (in real-time in some cases) for display. For instance, the dashboards 110 may be displayed to the customers/users 112 on their client devices so that they may review meeting activity, meeting presence, asset utilization, movement patterns, physical space utilization, and other data. A dashboard 110 may include one or more graphical user interfaces. The dashboard graphical user interfaces 110 may be rendered by a client application, such as a browser, another native application, a thin-client, executable code included in the dashboard, etc., to display the data provided by the interface 216.

FIG. 3 are plan views of example physical space layouts 301a . . . 301n associated with a stakeholder, such as a company. As shown, the physical space layouts 301a . . . 301n (also individually and or collectively simply referred to as 301) represent floors in the same or different buildings that include various different physical spaces, although it should be understood that a space layout may represent any type of indoor or outdoor facility, and that the layouts may be the same, similar, or different. The different spaces may be of any type. Example spaces include a lobby, a reception area, small, medium, large, and group-sized meeting/conference rooms, a pantry/meeting area, cubicles, individual offices, a mixed-use space, a pavilion, a penthouse, an observation area, an operating room, a preparation area, a staging area, or other suitable rooms.

More particularly, with reference to FIG. 3, two example physical spaces 302a and 302b are called out in detail for illustrative purposes. Physical space 302b is a medium-sized conference room designed to accommodate around nine people and physical space 302a is a large conference room designed to accommodate around 15 people. Each physical space 302 is equipped with various technological amenities (assets) to facilitate or observe meetings held in the room. For instance, installed in the physical space 302a are a whiteboard 304, a digital assistant 306 (e.g., Amazon Alexa™, Google Home™, etc.), a set of motion sensors 308, the digital meeting panel 310 (e.g., a wall-mounted touchscreen tablet running meeting software, such as EventBoard™), a phone system 306 including one or more terminals, a video-conferencing system 316, a telepresence system 318, a projector 312 that projects images on a wall or a screen and any necessary electronic ports to connect to the projector, and an access point 319 for connecting to the network 204, and a large-panel display 320 and any necessary electronic ports to connect to the display 320. Similarly, installed in physical space 302b are a whiteboard 304, a digital assistant 306, a set of motion sensors 308, a digital meeting panel 310, a projector 312 that projects images on a wall or a screen, a phone system 314, and a large-panel display 320 and any necessary electronic ports to connect to the display 320.

Other devices may also associated with the physical spaces 302a and 302b. For instance, a door access control device (e.g., card reader) 333 may be installed at the entrances of the floors 301, a large-format display 331 may be installed in the lobbies may serve as meeting status monitors showing real-time statuses for the different physical spaces (e.g., 302a and 302b), a sign-in panel 329 may be installed in the reception area and may be configured with software (e.g., LobbyConnect™) for prompting guests to sign-in prior to being admitted further into the floors 301, a digital assistant 306 located in a waiting area, etc., and an access point 319 that provides network access to client devices located in either of the physical spaces 302a and 302b.

Any of the devices installed in association with the physical spaces 302a and 302b may constitute nodes 222, maybe coupled to the network 204 via wired or wireless network interfaces, and may communicate network data via the network 204 with other endpoints within the network 204 or the network 206. The network data transmitted by the notes 222 may be filtered by one or more control points of the network 204 such as a firewall. For instance, in a packet-switched network, packets transmitted by a node 222 may be routed by switches included in the network 204 through a firewall out to public networks comprising the Internet. The network data may be metered by one or more meters 102 installed as part of the network infrastructure comprising the network 204, and analyze to determine utilization of the physical spaces 302a and 30b and/or assets installed in association with the physical spaces 302a and 302b.

Meetings may be held in the physical spaces 302a and 302b throughout a given workday. The meetings may be pre-scheduled, scheduled on demand, or automatically determined based on activity detected within the physical spaces 302a and 302b.

In some implementations, the system 100 may include a management server coupled to the network 104 via which may schedule meetings based on meeting requests received from endpoints of the system 100 using scheduling software operated by client devices (e.g., mobile user devices, laptops, displays 310 and 329, etc.). In addition, the management engine may provide installation management, visitor registration, and location scheduling (e.g., data, APIs, interfaces, etc.) to various endpoints in the system 100, such as the client devices. The scheduling/meeting request may specify different meeting characteristics including a date, a time, a location, equipment, attendees, meeting topic, meeting notes, etc., which may be input by a user using a meeting scheduling interface.

In some implementations, a meeting may be scheduled on demand upon arriving at a meeting room that is available using a display 310, scheduling software running on a mobile device of the user, a voice command to the digital assistant 306 (e.g., please ask Teem™ to schedule room 302a for the next hour). The management engine may receive the request from the device via which the meeting was scheduled, and/or any intervening computing systems (e.g., digital assistant management server), etc., and may schedule the meeting accordingly by creating and/or updating a corresponding entry in the data store 220 using the contemporaneous data associated with the request (time of the request, a default or specified duration, a user ID associated with the request, the physical space address associated with the request, etc.).

In some implementations, the system 100 may automatically determine if the meeting has begun based on implicit input provided by the user via the nodes 222. For example, as users begin to congregate in the physical space 302a or 302b, the nodes 222, which may include one or many, may detect presence, based on the motion/movement and/or noise produced by the users. For instance, the phone system 314, the motion sensor(s) 308, the video-conferencing system 316, the digital assistant 306, and/or the telepresence system 318 may include one or more a sound capture devices (e.g., a microphone), and one or more light sensing devices (e.g., digital image sensor) (e.g., CCD, CMOS, IR, depth sensor, LIDAR, other suitable optical sensor, etc.) adapted to capture the movement and/or noise of the people within the physical space 302a or 302b. The nodes 222 may process the input signals to quantify the movement and/or noise, and transmit the processed data (also called presence data, which may include quantified motion data and/or sound data) to the meter 102. The utilization monitor 210 may process the received and the utilization logger 212 may log the data in the data store 220 and/or provide it to the asset-space analyzer 218 for further analysis.

The asset-space analyzer 218 may evaluate the presence data (which may in some cases be stored in the data store 220 as activity data in association with the corresponding nodes 222, physical space, meeting entry, etc.) to determine whether an unscheduled meeting has started and/or ended in a given physical space. For instance, if the presence data includes data identifying four people-shaped objects were moving regularly within the physical space 302a beginning at 8:30 AM and ending at 8:58 AM, the asset-space analyzer 218 may determine that a meeting occurred within that timeframe and may generate and store a meeting entry in the data store 212 for the unscheduled meeting. Unscheduled meetings may be flagged as such in the data store 212, and metrics reflecting the number of unscheduled meetings that occur within an organization on a regular basis (e.g., daily, weekly, monthly, yearly, etc.) may be provided in the interface by the dashboard 110 for interaction with by a stakeholder representative.

Regular movement may be determined by the asset-space analyzer 218 based on the length and/or frequency of dead periods within the data. A dead period is period of time in which little or no motion and/or noise was detected. A predetermined threshold, which may be adjustable, and be used by the asset-space analyzer 218 to determine whether or not dead period should be interpreted as meaning that the meeting has ended.

FIGS. 4A and 4B portray example activity data processed by a meter 102. FIG. 4A in particular shows a dataset 400 including example sets of data 420 that have been processed by the network data processor 206, the asset filter 208, and the utilization monitor 210. As shown, a given set of data 420 may include an electronic address 402 (e.g., IP address) of the node 222, a device identifier 404 (e.g., MAC address), a device classification 406 (e.g., a device type and/or manufacturer and/or model), a physical space identifier 408 (e.g., a common name for the space, a geographic address, a unique character string, etc.), and a timestamp 410 reflecting when the network data was communicated (received or transmitted), although should be understood that additional and/or alternative data and data types may be included, such but as not limited to the action being taken by a node 222, a protocol being used by a node 222, etc. Each of the sets of data 420 may represent the same and/or different devices, depending on the assets being utilized in the physical spaces being monitored. For instance, compared to the other spaces in the data set 400, the nodes 222 (representing Alexa, VC System, etc.) in the space labeled “The Schwartz” were more active than the nodes 222 of the other spaces (e.g., Banana Stand, Glass Case of Emotion, Center for Ants, Death Star) for that given time period.

In some implementations, the asset filter 208, when processing the parsed packet data provided by the network data processor 206, associate the IP address and/or MAC Address of the nodes 222 with the physical spaces to which they correspond (e.g., are installed in, are monitoring, etc.). As discussed elsewhere herein, the asset filter 208 may associate a given node 222 with a particular space using identifying information for the node 222, such as the node identifier 402 and/or device identifier 404, and a mapping, such as the asset database, that maps the node identifier 402 and/or device identifier 404 with a unique space identifier.

In cases where a node 222 is unrecognized by the asset filter 208, the asset filter 208 may find the node 222 as unrecognized, and a dashboard 110 may prompt a stakeholder representative to confirm the space with which the unrecognized node 222 is associated (e.g., is installed in, is monitoring, etc.) and/or to confirm the device type of the node 222. For example, as depicted in FIG. 4B, the data set 450 includes an entry in which the device classification 412 and the space 414 are not yet confirmed. The dashboard 110 may present an interface including graphical interface input elements, such as the drop downs 417 and 418 depicted in FIG. 4B, with which the user may interact with an input device of the client device they are using to view the interface. The user may select the input elements to confirm a suggestion generated by the meter 102, such as the suggestion made in association with element 417 that the node 222 should be classified as a digital assistant device (e.g., Alexa) in FIG. 4B.

In a further example, the user may select an input element to select from an array of options displayed upon selection of the graphical input element (e.g., a drop-down menu), may manually input a character string defining the data to be confirmed, or input data in another suitable manner. For instance, as shown in FIG. 4B, the user may select element 419 to select from a list of predefined physical spaces stored in the data store 220 and retrieved therefrom using a data query, may input the identifying information of a particular physical space already known to the user, or may select an option to define a new physical space and associate the node 222 without space. Other variations are also possible and contemplated.

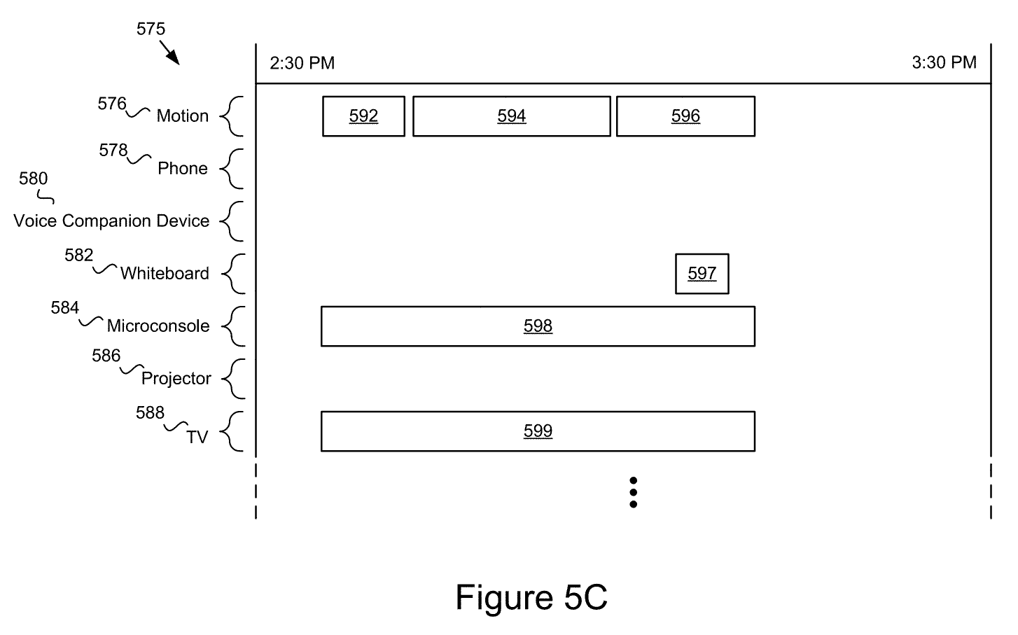

FIG. 6 is a flowchart of an example method 600 for determining utilization of physical asset based on monitored network node activity. In block 602, meter(s) 102 are deployed on computing system(s) (e.g., a server, firewall hardware, etc.) that are configured to receive network data. In some implementations, the method 600 may deploy a meter 102 coupled to a private computer network. A meter 102 may be manually deployed, or installed automatically by an interface 216 of the utilization server 106, which may be programmed and authorized to install meter(s) 102 in a network 204 of a given stakeholder. In some implementations, authorization data (e.g., a pre-authorized token, login credentials, etc.), may be stored in the data store 212 and retrieved by the installation interface 216 when installing the meter 102, which may be embodied by one or more objects stored and retrieved from the data store 212, transmitted to computing system coupled to the network 204, and installed in the computing system. For instance, the installation interface 216 may open a secure data tunnel into the network 204 and install the meter 102 as an agent (e.g., daemon, cron job, server, etc.) that is configured to meter data as described herein. In further examples, the installation may be performed manually. Other variations are also possible and contemplated.

The meter 102 may capture network data sent or received by network nodes 222 coupled to the private computer network. Each of the nodes 102 may be associated with a particular physical space, and in the aggregate, portions or groups of the network nodes may be associated with different physical spaces (e.g., a first group with a first physical space, a second group with a second physical space, and so on). In some cases, a node 222 may be associated with more than one physical space, such as an access point, a meeting display, a key reader, etc., and the meter 102 may

In some implementations, nodes 222 installed in one or more facilities may be coupled to a network monitored by the computing system(s). The meter(s) 102 installed in association with those facilities may capture the network data transmitted by the nodes 222 by virtue of the network traffic being routed through the computing system(s) to various intended designation nodes, whether located on the private network or public network.

For instance, the method 600 may deploy a meter 102 in association with a gateway of a private computer network. The meter 102 may be coupled to and/or integrated into the gateway and may capture packet data sent or received by network nodes 222 coupled to the private computer network and located behind the gateway of the private computer network. For instance, by being associated with the gateway of the network, which may include a firewall, the meter 102 may leverage the packet processing performed by the gateway in protecting the network from unauthorized access. In these or other implementations, portions or groups of the network nodes 222 may be installed with different physical spaces within the premises. For instance, a first portion of the network nodes 222 may be installed in association with a first physical space within the premises, and a second portion of the network nodes may be installed in association with a second physical space within the premises, and so on.

In block 608, the meter 102 monitors activity of the network nodes 222 in association with the different physical spaces based on the captured network data. For instance, by processing the header and payload information of the captured data units, the meter 102 may determine the device types for the nodes 222 and may associate the nodes 222 with the different physical space with which they are associated (e.g., first physical space, second physical space, etc.), as discussed in further detail elsewhere herein.

In block 610, the space-asset analyzer 218 determines, for a particular period of time, a utilization of a physical asset, which is located in a particular physical space of the different physical spaces, based on the monitored activity of a network node from the network nodes that represents the physical asset

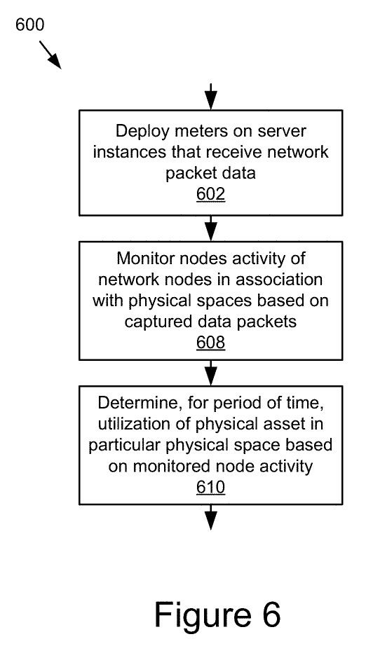

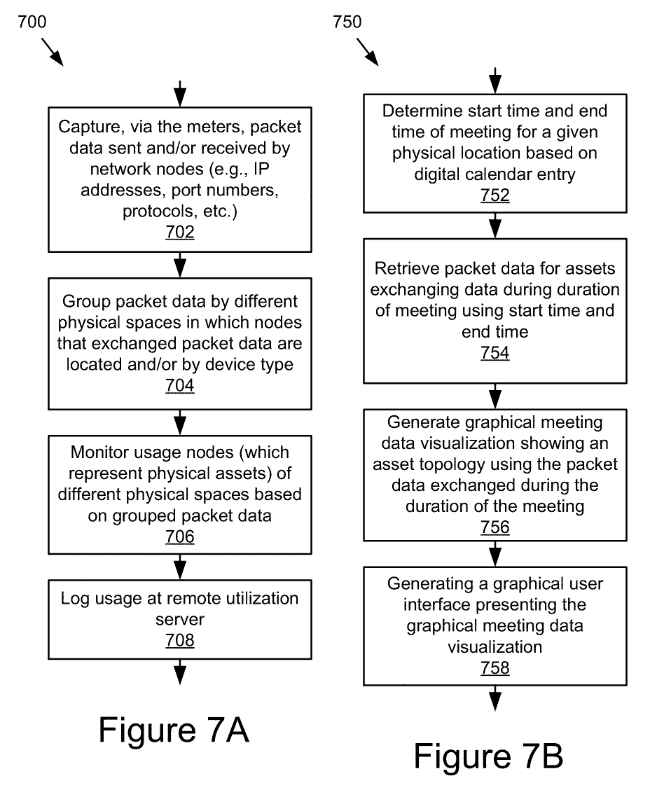

FIG. 7A is a flowchart of an example method 700 for capturing and grouping packet data associated with different physical spaces.

In block 702, the asset filter 208, executing at the meter 102, groups captured packet data according to the different physical spaces in which the network nodes 222 that sent or received the packet data are located. In some implementations, the asset filter 208 may monitor activity of the network nodes 222 based further on different groups with which the captured packet data are associated. The different groups may represent the different physical spaces in which the network nodes are associated, as discussed elsewhere herein, such as with reference to FIGS. 3-4B.

For example, continuing an example described in reference to FIG. 6, as part of the monitoring, the asset filter 208 may group the captured packet data received from the first portion of the network nodes with a first identifier uniquely identifying the first physical space, and group the captured packet data received from the second portion of the network nodes with a second identifier uniquely identifying the second physical space.

In block 704, the utilization monitor 210 executing on the meter 102 monitors node activity of the different physical spaces based on the grouped packet data. For example, continuing the example above, the utilization monitor 210 monitors the activity of the first portion of network nodes in association with the first physical space. The monitoring may be based on the first portion of network nodes being grouped with the first identifier, which uniquely identifies the first physical space. Similarly, the utilization monitor 210 monitors the activity of the network nodes of the second portion in association with the second physical space, which may also be based on the second portion of network nodes being grouped with the second identifier, which uniquely identifies the second physical space.

The space-node grouping and activity monitoring is advantageous as it allows the system 100 to determine what physical space the sets of network captured network traffic are associated with, and by extension based on the activity, the volume, timing, regularity, and/or duration of that traffic for each node 222. The system 100 may analyze the space-associated network traffic data to determine how and when the physical space is being utilized, whether and which computing assets in the physical space are actively utilized, whether the assets in the physical space are malfunctioning and how often, etc. This activity data can be used by the system 100 to reliably determine asset utilization and space utilization for the physical location, thus solving a long-standing problem as described in the Background.

In block 708, the utilization logger 212 logs, at a utilization server, the activity of the first portion of network nodes and the activity of the second portion of the network nodes. In some implementations, the utilization logger 212 may connect directly to the data store 220 and store the data, while in further implementations, the utilization logger 212 may call a storage method or other procedure surfaced by the asset utilization monitor 108 (e.g., via an interface 216), or execute other suitable operations for storing the data in the data store 220. In some implementations, the utilization logger 212 may access an API of the asset utilization monitor 108 and provide the data being logged the space-asset analyzer 218, which may in turn, analyze, store, and/or generate utilization data using the logged activity data. Other variations are also possible and contemplated.

FIG. 7B is a flowchart of an example method 750 for generating an asset topology. In block 752, the asset-space analyzer 218 may retrieve activity data reflecting the activity of the network nodes 222 sending or receiving data during the particular period of time and associated with the particular physical space. The particular period of time may reflect a meeting conducted in the particular physical space. The activity data may be processed from and/or include network data for assets communicating network data during the duration of a meeting in a physical space, as discussed elsewhere herein.

In some implementations, the asset-space analyzer 218 may determine a start time and an end time of a meeting held in the physical space. The start time and end time may be defined in a meeting entry stored in the data store 220, and the asset-space analyzer 218 may retrieve the activity data from the data store 220 and process the retrieved results for the start and end times. In some implementations, the asset-space analyzer 218 may receive, from an interface 216, user input specifying the start and end times or may receive parameter(s) for querying the data store 220 for the start time and the end time, such as a meeting identifier identifying the particular meeting, a space identifier for the space and a time range, etc. In some implementations, the asset-space analyzer 218 may be analyzing some or all meetings held throughout the day, may iteratively be processing each meeting, and in doing so, may retrieve the meeting information. Other variations are also possible and contemplated.

In block 754, the asset-space analyzer 218 may generate a graphical meeting data visualization showing an asset topology for the particular physical space using the packet data reflecting activity of the network nodes during the particular period of time.

In block 756, a client device may display, on a display device to a stakeholder, the graphical meeting data visualization in a graphical user interface (e.g., of the dashboard 110), and a user may interact with the data visualization.

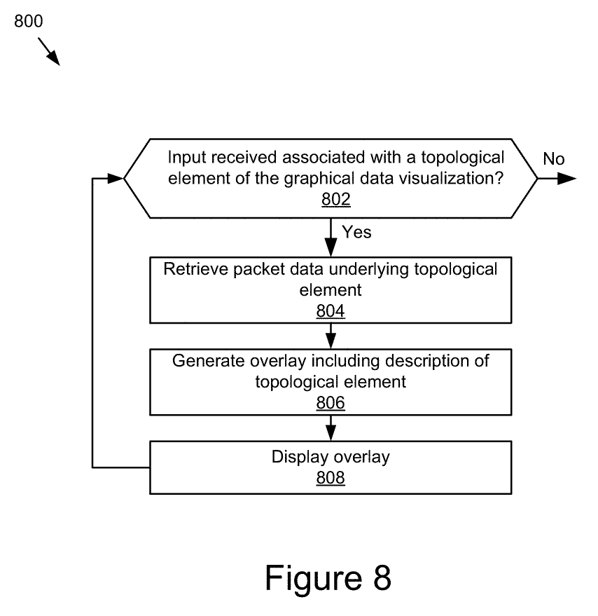

FIG. 8 is a flowchart of an example method 800 for processing topology-related input. In block 802, the dashboard 110 receives input associated with a topological element of the graphical data visualization via an input device. A user may provide the input by interacting a graphical user interface of the dashboard 110 displayed on a display device that is coupled to the input device and controlled by one or more computing processors. The dashboard 110 interface may include the graphical data visualization and may dynamically display and/or hide contextual data as the user interacts with aspects of the topology. The contextual data may describe additional insights into the activity by nodes 222 during a particular period of time, such as during a meeting.

In block 804, the dashboard 110 retrieves contextual data reflecting network activity associated underlying the topological element for which input was received in block 802. The contextual data may include more detailed activity data than what is displayed in the selected topological element, may provide data contrasting the topological element with activity by other nodes 222 or nodes 222 of the same type during other meetings, or other suitable insights, such as any data stored in the data store 220 and/or determined by the asset-space analyzer 218 that is associated with, or can be contrasted with, the topological element.

The contextual data may be retrieved from local memory (e.g., a memory of the client device on which the dashboard 110 is operating), or may retrieve the underlying data from the server 106. For instance, the dashboard 110 may execute an asynchronous call, via the network 206, to an interface 216 of the monitor 108 or the data store 220 more directly, which may include parameter(s) defining the topological element of interest, which my interpret the call and query the data store 220 for the data, and provide the requested data via the network 206 to the dashboard 110. The contextual data may be retrieved from the data store 220 or local memory using the parameter(s), such as a node 222 identifier and a particular time period represented by the topological element, or a unique identifiers for the topological element, or another suitable key, although other variations are possible and contemplated.

In block 806, the dashboard 110 and/or another component (e.g., an interface 216, other client application, etc.) may generate a graphical element including contextual data for the topological element, and in block 808, may display the graphical element providing a description of the topological element in association with the topological element. For example, the graphical element may be an overlay overlaid over the topological element in the graphical user interface, a window the user is redirected to (which may be closed to return to the interface displaying the topological element, may be an expansion of the topological element in which aspects of the topological element are annotated or augmented to call out additional contextual details, etc. Numerous further variations are also possible and contemplated.

In some embodiments, in interacting with the interfaces generated and presented by the system 100, a user may view technology usage in a given location (e.g., room), view the amount spent on the assets in a particular location relative to the usage of those assets (e.g., realization, return on investment, etc.), compare meeting invite start time to an actual start time based on motion and technology interaction within the room, identify issues with various assets in the room (e.g., non-responsive asset, non-utilization of a typically heavily or moderately utilized asset as reflected by the network data being received, identify issues with end users based on stop patterns in technology usage, etc.

For example, a user may select a graphical element (e.g., an entry associated with a particular asset, and upon doing so, the dashboard 110 may render an overlay, a separate window, or other graphical container that displays constituent data for that graphical element, such as the raw packet data received during a timeframe for the graphical element, comparative data of the same type of asset aggregated from other locations as discussed elsewhere herein (e.g., average use of that type of asset across an organization, building, group, or other segmentation (e.g., demographic, etc.)), historical network data for that asset, which may be interacted with and/or navigated by a user to determine (e.g., adjacent graphs for different time periods, a graph showing averages, other suitable data visualizations, tabular data, etc.).

In some cases, a map of an area or areas (floor, courtyard, etc.) with graphical indicators of the assets and a real time data view of the assets may be presented in the dashboard 110. Layouts of the different areas may be stored in the data store 220 and retrieved by the space-asset analyzer 218. The space-asset analyzer 218 may query the data store 220 for the assets of the locations within the area, and may retrieve network data for those assets as logged by the utilization logger 212 (e.g., from memory, the data store 220, etc.). The space-asset analyzer 218 may generate a data structure (e.g., JSON, XML, other file, etc.) that correlates the network data and asset information, and may provide that data structure to the dashboard 110, which may process the data structure and render a graphical data visualization showing a layout of the area, the locations within the area, the assets within and/or associated with the locations, etc. An end user, using an input device, may interact with (e.g., hover over, tap, etc.) the different assets within a given location and visualize, based on the graphical elements dynamically displayed on screen in response to the input, the activity of the different assets over time and/or any errors and/or other events that may be occurring and/or have occurred. In some instances, the interface displaying the graphical visualization of the area may be a real time (updated responsive to network data is logged) or historical representation of the area and/or the asset usage within that area. For instance, the graphical user interface may include a time selector for indicating which timeframe for which data should be displayed (e.g., now, last hour, a particular time and day, etc.), and the dashboard 110, based on data received from the space-asset analyzer 218 (e.g., via an applicable interface 216), may update the graphical visualization of the area. Numerous other variations are also possible and contemplated.

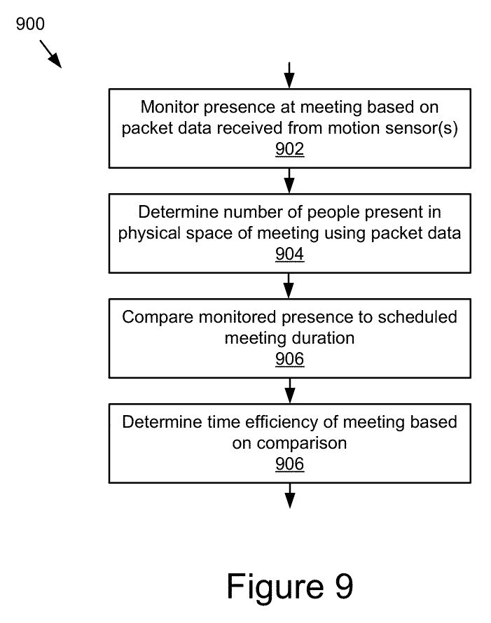

FIG. 9 is a flowchart of an example method 900 for monitoring meeting presence and determining meeting efficiency. In block 902, the meter 102 monitors presence in the particular physical space based on presence data, such as motion and/or noise packet data, received from one or more presence sensors (e.g., motion, noise, etc.) associated with the particular physical space. The presence data may describe the motion by one or more people located in the particular physical space.

In some implementations, the presence sensors may be dedicated sensors for detection motion and sound, or may be technological devices used during a meeting that are advantageously used for detecting motion and sound in addition to serving their intended purpose (e.g., providing digital assistance, telephony, video conferencing, telepresence, etc.). In a more particular example, the captured presence data may include the motion packet data communicated during a particular period of time (e.g., which reflects a meeting conducted in the particular physical space), and the network nodes 222 may include motion sensor(s). The captured data may be processed and logged as described elsewhere herein.

In block 904, using the presence data and meeting-related data, the asset-space analyzer 218 may perform a comparison between the actual start time and the actual end time of the meeting to a scheduled meeting duration associated with a stored meeting entry, may compare, in block 906, the monitored presence to the scheduled meeting duration, and determining a meeting efficiency score for the meeting based on the comparison. For example, if a meeting was scheduled to last for an entire hour (e.g., from 9-10 AM), but the network data received from nodes 222 in the room reflect that node activity did not extend over the entire period (went from 9:05 AM to 9:35 AM), than the utilization monitor 210 and/or the asset-space analyzer 218 may generate a score reflecting the underutilization of the room and assign the score to the meeting entry in the data store 220.

Analytics data provided via the dashboard 110 may reflect the underutilization of the physical space, and data describing the meeting may be annotated to reflect the score and/or highlight that the meeting was inefficient. In an example where the meeting is a reoccurring meeting, and historical activity data demonstrates that the meeting generally starts late and ends early as in the above example, the dashboard 110 may present data recommending the meeting be shortened to a half hour, and/or provide a notification (via email, text message, the organizer's calendar application, or other medium) to the organizer to change the meeting to a half hour (e.g., extending from 9-9:30 AM).

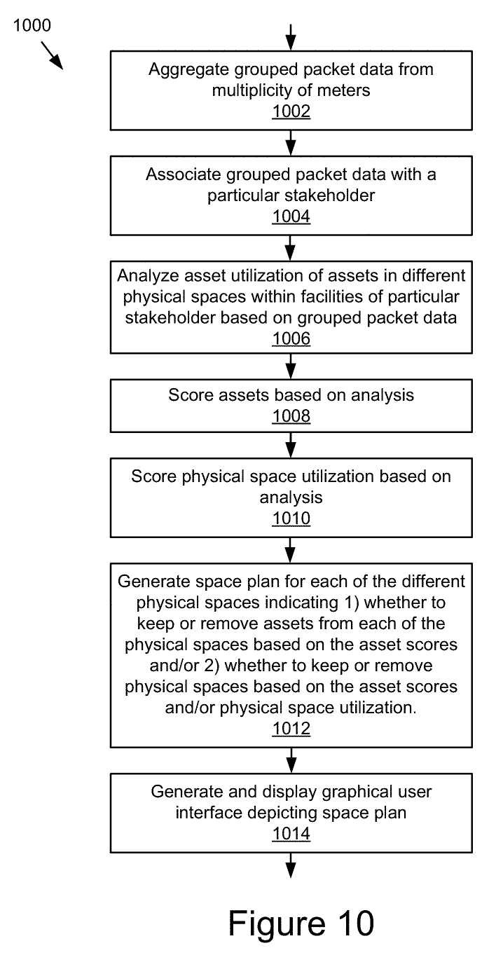

FIG. 10 is a flowchart of an example method 1000 for analyzing network data to determine a space plan. In block 1002, the meters 102 may aggregate group network data from one or more meters 102, and in block 1004, may associate the group network data with a particular stakeholder. In block 1006, the space-asset analyzer 218 may analyze the asset utilization of the assets in the different physical spaces within facilities of the particular stakeholder based on the grouped network data. In block 1008, the space-asset analyzer 218 may score the assets based on the analysis.

In some implementations, the asset-space analyzer 218 may generate a score for a particular asset type embodied by a node 222 based on, but not limited to, one or more of:
the number of times the node 222 transmitted substantive activity data during meetings,
the duration of the transmissions of substantive activity data, and
the number of times that type of asset was used in different physical spaces during different meetings (network data is received from different nodes 222 all classified as that type of device/asset).

In some implementations, the asset-space analyzer 218 may generate a score for each one of the above factors, and generate a combined score reflecting the score for that asset type. The asset-space analyzer 218 may store the scores in the data stores in association with the nodes 222 and/or asset types to which they apply. When generating a space plan reflecting the value of the current assets installed in the stakeholders facility(ies), and/or to be included in a future facility, the asset-space analyzer 218 the use of scores to annotate the assets with the relative value in a space plan, and, for a given size of physical space (small, medium, large, etc., meeting room, may recommend the assets that are the most utilized as reflected by the scores.

In block 1010, the asset-space analyzer 218 may score physical space utilization based on the asset analysis. In some implementations, since the asset-space analyzer 218 may determine an attendance profile for each meeting conducted in the physical spaces, as well as determine the actual start times and end times of the meetings conducted in the physical spaces of the facilities of the stakeholder, the asset-space analyzer 218 may combine the analysis to determine whether each of the physical spaces were fully utilized during a meeting, in terms of the number of people present relative to the number of people the physical space could accommodate, and duration of the meeting relative to the scheduled meeting duration (if applicable).

Based on this, the asset-space analyzer 218 may determine that the employees of the company prefer to meet in groups of certain sizes (which exceed or underutilize the available room in the existing physical spaces), may compare the preference to the actual physical space layouts of the stakeholder, and generate recommendations to eliminate, modify, and/or add additional physical spaces to conform the physical space layouts of the stakeholder to the preference of the employees to meet. The asset-space analyzer 218 may further refine the analysis by segmenting the data based on time of day, the types of employees that meet, the geographic locations of the different physical spaces, etc., all of which may affect which sizes of rooms and/or assets within the rooms are preferred by the employees, in which the asset-space analyzer 218 may consider the recommendations generated and included in the space plan and/or other data presented by a dashboard 110.

In block 1012, the asset-space analyzer 218 generates a space plan for one or more (e.g., each) of the different physical spaces of the stakeholder indicating whether to keep or remove assets from each of the physical spaces based on the asset scores, whether to keep or remove physical spaces based on the asset scores and/or physical space utilization, and/or any other determinations discussed herein.

In block 1014, the dashboard may generate and display graphical user interface depicting the space plan for interaction with by the stakeholder representative, which may include dynamic and interactive elements similar to that discussed with reference to the asset topologies for viewing additional information about different physical spaces and/or assets, such as their use, their comparative use to other physical spaces and/or assets, etc.

FIG. 11 is a block diagram of an example computing system 1100. The computing system 1100 may represent the computing architecture of a meter 108, a utilization server 106, a client device, and/or other computing systems of the system 100, and my include some and/or of the illustrated components. As depicted, the asset utilization monitor 108 may include a processor 1102, a memory 1104, and a communication unit 1108, and the data store 220, which may be communicatively coupled by a communication bus 1106. The computing system 1100 depicted in FIG. 11 is provided by way of example and it should be understood that it may take other forms and include additional or fewer components without departing from the scope of the present disclosure.

The processor 1102 may execute software instructions by performing various input/output, logical, and/or mathematical operations. The processor 1102 have various computing architectures to process data signals including, for example, a complex instruction set computer (CISC) architecture, a reduced instruction set computer (RISC) architecture, and/or an architecture implementing a combination of instruction sets. The processor 1102 may be physical and/or virtual, and may include a single core or plurality of processing units and/or cores. In some implementations, the processor 1102 may be capable of generating and providing electronic display signals to a display device (not shown), supporting the display of images, capturing and transmitting images, performing complex tasks including various types of feature extraction and sampling, etc. In some implementations, the processor 1102 may be coupled to the memory 1104 via the bus 1106 to access data and instructions therefrom and store data therein. The bus 1106 may couple the processor 1102 to the other components of the computing system 1100 including, for example, the memory 1104, the communication unit 1108, the data store 220, etc.

The memory 1104 includes one or more a non-transitory computer-usable (e.g., readable, writeable, etc.) media that can contain, store, communicate, propagate, or transport instructions, data, computer programs, software, code, routines, etc., for processing by or in connection with the processor 1102. In some implementations, the memory 1104 may include one or more of volatile memory and non-volatile memory. For example, the memory 1104 may include, but is not limited, to one or more of a dynamic random access memory (DRAM) device, a static random access memory (SRAM) device, a discrete memory device (e.g., a PROM, FPROM, ROM), a hard disk drive, an optical disk drive (CD, DVD, Blue-Ray™, etc.). It should be understood that the memory 1104 may be a single device or may include multiple types of local and/or distributed devices and configurations.

The memory 1104 may store and provide access to data to the other components of the computing system 1100. In some implementations, the memory 404 may store instructions and/or data (e.g., software, etc.) that may be executed by the processor 402. In some implementations, one or more of the components 102, 108, 110, etc., may be implemented using software executable by one or more processors of one or more computer devices, using hardware, such as but not limited to a field-programmable gate array (FPGA), an application-specific integrated circuit (ASIC), etc., and/or a combination of hardware and software, etc., all of which are encompassed by this disclosure.

The computing system 1110 may represent the computing architecture of a server, a client device, an embedded device, virtualized hard components emulated by other underlying computing system(s) 1100, etc. In some implementations, depending on the configuration of the computing system 1100, the memory 1104 may store one or more instances the meter 102, the monitor 108, and/or the dashboard 110. As further non-limiting examples, a meter device (an instance of a computing system 1100) may have a memory 1104 that stores an instance of the meter 102; a server 106 may have a memory 1104 that stores an instance of the asset utilization monitor 108, a client device (an instance of the computing system 1100) may have a memory 1104 that stores an instance of the dashboard 110); etc. However, it should be understood that, in further implementations, these aspects may be consolidated and/or further divided into additional components and/or may operate on the same or disparate computing systems 1100. The memory 1104 is also capable of storing other instructions and data, including, for example, an operating system, hardware drivers, other software applications, databases, etc. The memory 1104 may be coupled to the bus 1106 for communication with the processor 1102 and the other components of the computing system 1100.

The bus 1106 can include a communication bus for transferring data between components of a computing device or between computing devices, a network bus system including the network 104 or portions thereof, a processor mesh, a combination thereof, etc. In some implementations, the meter(s) 102, the server(s) 106, the client device(s), and various other computer programs operating in the system 100 (e.g., operating systems, device drivers, etc.) may cooperate and communicate via a software communication mechanism included in or implemented in association with the bus 1106, which is capable of facilitating inter-process communication, procedure calls, object brokering, direct communication, secure communication, etc.

The communication unit 1108 may include one or more interface devices (I/F) for wired and wireless connectivity with the other components of the system 100. For instance, the communication unit 1108 may include, but is not limited to, CAT-type interfaces; wireless transceivers for sending and receiving signals using Wi-Fi™; Bluetooth®, cellular communications, etc.; USB interfaces; various combinations thereof; etc. The communication unit 1108 may couple to and communicate via the network 104 (e.g., networks 204, 214, etc.), and may be coupled to other components of the system 100 via the bus 1106. In some implementations, the communication unit 1108 can link the processor 1102 to a network, which may in turn be coupled to other processing systems. The communication unit 1108 can send and receive data using various standard communication protocols, including, for example, those discussed elsewhere herein.

The meter 102, the asset utilization monitor 108, and/or the client application 1110, may include various sub-components for performing various different acts, operations, and/or functions. For instance, the meter 102 may include the network data processor 206, the asset filter 208, the utilization monitor 210, and the utilization logger 212; and the asset utilization monitor 108 may include the interface(s) 216 and the space-asset analyzer 218, as discussed elsewhere herein. The meter 102, the asset utilization monitor 108, and/or the client application 1110, and/or their various sub-components, may be coupled (e.g., via the processor 1102) to one another and the other components of the computing system 1100 (as applicable) for communication and interaction. In some implementations, meter 102, the asset utilization monitor 108, and/or the client application 1110, and/or their various sub-components, are sets of instructions executable by the processor 1102 to provide their acts, operations, and/or functionality. In some implementations, meter 102, the asset utilization monitor 108, and/or the client application 1110, and/or their various sub-components, are stored in the memory 1104 of the computing system 1100 (as applicable) and are accessible and executable by the processor 1102 to provide their acts, operations, and/or functionality. In any of the foregoing implementations, meter 102, the asset utilization monitor 108, and/or the client application 1110, and/or their various sub-components, may be adapted for cooperation and communication with the processor 1102 and other components of the computing device 1100 (as applicable).

While the meter 102, the asset utilization monitor 108, and/or the client application 1110, are shown as including various sub-components for performing various different acts, operations, and/or functions, it should be understood that other configurations are possible and contemplated. For example, some or all of the components 102, 206, 208, 210, 212, 108, 216, 218, and/or 110 and/or functionality or acts thereof, may be combined or segmented into further components, shifted from client-side to server side, etc. Additionally, the components, or some or all of their functionality and/or acts, may be integrated into other software or hardware without departing from the scope of this disclosure.

Further, it should be understood that the utilization server 106 may, in some implementations, represent a distributed computing system, such as a cloud-based environment, and that the components 206, 208, 210, and 212 of the asset utilization monitor 108 may be hosted on any combination of distributed computing devices and the mapping unit 210 may coordinate the operations of and interaction between the various components of the asset utilization monitor 108, although in further implementations the utilization server 106 may be a stand-alone server 106 or set of servers 106, and/or may be located within the network 204. Numerous other variations are also possible and contemplated.

The data store 220 is an information source for storing and providing access to data 330. In some implementations, the data store 220 may be coupled to the asset utilization monitor 108 to receive and provide access to data. In some implementations, the data store 220 may store data 330 received from other elements of the system 100 include, for example, the meter(s) 102, the dashboard(s) 110, the asset utilization monitor 108, an FIRMS platform hosted by the third-party server 150, networking hardware and/or software comprising the network 204 and/or 214, etc. Examples of the types of data stored by the data store 220 are discussed elsewhere herein.

The data store 220 may be included in the computing system 1100 or in another computing device and/or storage system distinct from but coupled to or accessible by the computing system 1100. The data store 220 can include one or more non-transitory computer-readable mediums for storing the data discussed herein. In some implementations, the data store 220 may be incorporated with the memory 1104 or may be distinct therefrom. In some implementations, the data store 220 may include a database management system (DBMS) operable on the computing system 1100. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

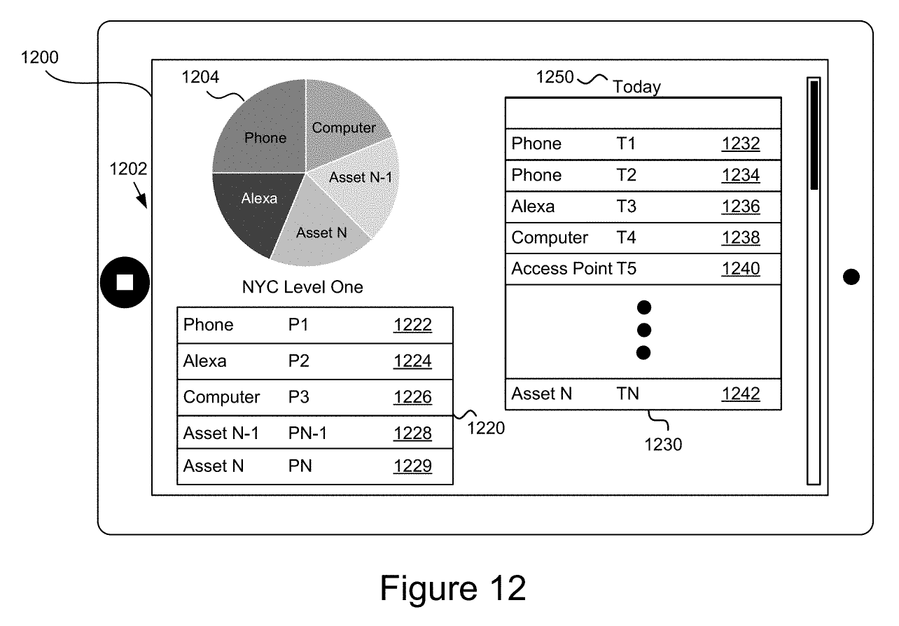

FIG. 12 is a graphical representation of a graphical user interface 1200 providing a utilization overview. As shown, a display device 1202 (such as those discussed elsewhere herein) may display the graphical user interface 1200 portraying a utilization overview for a given premises (e.g., the first floor of a company building in NYC). The overview may break down usage of various nodes 222 for a given premises, as detected by the system 200.

The graphical user interface 1200 may include an asset utilization summary 1230 reflecting the utilization duration of the nodes 222 during a given period of time 1250 (e.g., Today, yesterday, etc.). The summary 1230 may list instances in which the nodes 222 were utilized during the period 1250. For example, the summary 1230 may include a list of entries 1232, 1234, 1236, 1238, 1240, . . . 1242, reflecting the instances in which the assets were utilized. Each entry may include relevant data about the particular node 222, such as its type, electronic address, location, duration of use, etc. For instance, as shown, entries 1232, 1234, 1236, 1238, 1240, . . . 1242 include identifiers identifying the particular assets and amounts of time T1, T2, T3, T4, T5, . . . TN the nodes 222 were utilized.

In some cases, a user may select a graphical element displayed in the interface 1200 to set the utilization period 1250 (e.g., by tapping Today, the dashboard 110 may render a graphical calendar or another input field (e.g., text field, drop down menu, etc.) providing the user with options for selecting the time frame 1250 (e.g., date, time range, etc.).

The graphical user interface 1200 may include one or more data visualizations comparatively displaying utilization of the nodes 222 for the premises during the period 1250. Example data visualizations include graphs, charts, and other suitable visualizations illustrating the level at which different nodes 222 are used (e.g., which nodes are used most, least, etc.). The data visualizations reflect which nodes 222 experience the highest percentage of use, and/or provide other salient information relevant to the performance or non-performance, utilization or under-utilization, etc., of nodes in the various locations of the premises.

An example data visualization, the pie chart 1204, is depicted in FIG. 12, although other suitable types of data visualizations are also possible and contemplated. The data visualization 1204 shows which particular nodes 222 and/or types of nodes 222 were used the most during the period 150 for the facility and/or location (e.g., in this example case, the first floor of the building in NYC). The data visualization is supplemented in the depicted example with the summary 1220, which includes entries 1222, 1224, 1226, 1228, . . . 1229 having identifiers identifying the nodes 222 or node types, and the total periods of time P1, P2, P3, PN−1, . . . PN during which the nodes 222 or node types were utilized.

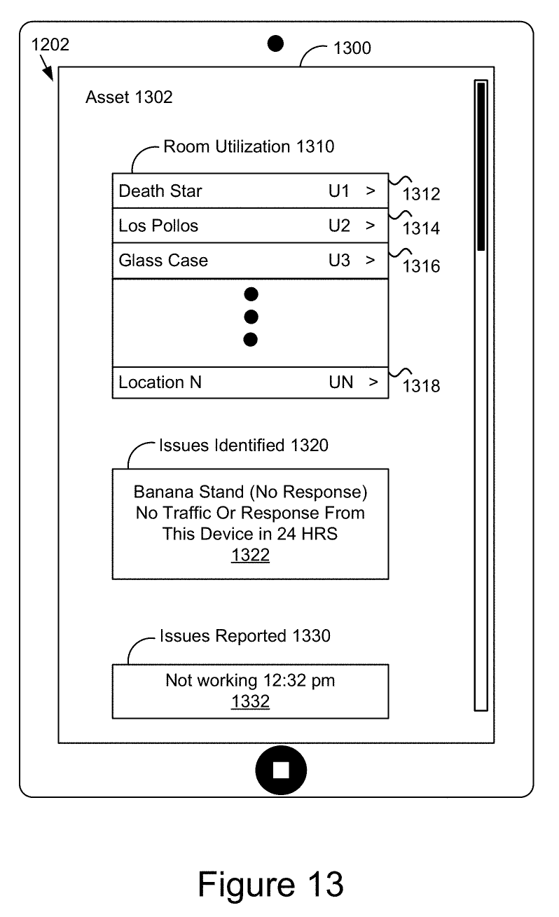

FIG. 13 is a graphical representation of a graphical user interface 1300 providing an asset overview. The interface 1300, which may be presented on the display device 1202, may include, for a given node/asset type 1302, content regions reflect utilization, performance, issues, device-specific information (e.g., IP addresses, MAC addresses, etc.), etc. about the assets belong to that type 1302. For instance, as shown, the interface 1300 may include a detailed summary 1310 about the utilization of the asset, a summary 1320 of technical issues automatically identified with the asset, and a summary 1330 of issues reported by user(s) about the asset 1302. To arrive at the interface 1300, a user may select a graphical interface element identifying the asset 1302 from a summary of assets, such as summary 1230 in FIG. 12, a graphical element from the interfaces discussed with reference to FIGS. 4A-5C, or another suitable interface presented by the dashboard 110.

As shown, the detailed summary 1310 may reflect utilization of the asset by location (e.g., room). For example, the detailed summary 1310 include a list of entries 1312, 1314, 1316, . . . 1318 listing the locations in which a particular asset type 1302 is located along with utilization rates by location (e.g., U1, U2, U3, . . . UN). The utilization rates may reflect the amounts of time the asset 1302 was utilized in the list of locations, may reflect percentages of utilization relative to utilization of other assets in the locations, etc.

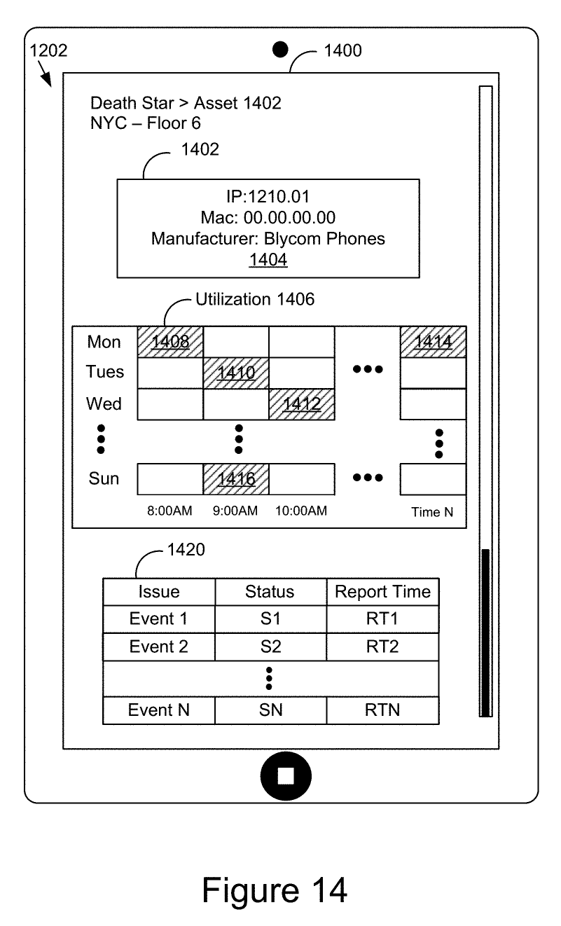

The summary 1320 of technical issues may include a list of technical problems that have been identified in association with the asset type 1302. In some cases, each entry (e.g., entry 1322) in the summary may include an indication of the specific device, the location in which the device resides and/or is associated, a description of the technical issue, a flag indicating whether the issue has been resolved, a flag indicating whether a service request has been submitted to address the issue, and/or other suitable information related to the issue, etc. The summary 1320 may reflect issues automatically identified by the system 200. In some cases, a user may select the entry 1322 to view additional information about the identified issue in a corresponding interface, such as a pop-up, overlay, or subsequent window. An example of detailed information about a specific node 222, including issue-related information, is depicted in FIG. 14.

The summary 1330 may reflect user-submitted issues related to the asset type 1302. For example, entry 1332 of summary 1330 may reflect that a particular device within a particular location is not working. For instance, the entry 1332 may include an indication of the specific device, the location in which the device resides and/or is associated, a description of the issue reported by the user, a flag indicating whether the issue has been resolved, a flag indicating whether a service request has been submitted to address the issue, and/or other suitable information related to the issue, etc. In some cases, a user may select the entry 1332 to view additional detailed information about the identified issue in a corresponding interface, such as a pop-up, overlay, or subsequent window. An example of detailed information about a specific node 222, including issue-related information, is depicted in FIG. 14.

FIG. 14 is a graphical representation of a graphical user interface 1400 providing a detailed view of a particular node 222 (labeled asset 1402) belonging to asset type 1302 of FIG. 13. The interface 1400 may include particular detailed information about the asset, such as utilization and issue-related information. For example, the interface 1400 may include asset-specific information, such as device-identifying information, manufacturer information, and/or other information, such as that discussed elsewhere herein.

The interface 1400 may include the utilization table 1406, which may reflect utilization of that particular device over time. For example, the utilization table 1406 may be a matrix that maps the days of the week with times of day and shows which timeslots the asset 1402 is being used in, such as timeslots 1408, 1410, 1412, 1414, and 1416. This matrix can advantageously provide an efficient way for a viewing user to determine patterns of use of the asset 1402.

The interface 1400 may include an issue summary 1420, that summarizes the issues automatically identified by the system 200 and/or reported by users, as discussed elsewhere herein. For example, the entries in the issue summary 1420 may identify events that have occurred over time (e.g. event 1 through event N), may identify the statuses in resolving the events (e.g., S1 through SN), and may identify the time in which the events reported (e.g., RT1 through RTN). An example event may be that a user reported static on the asset 1402 (e.g., a VOIP phone) during call conducted from the asset 1402 located in the location (e.g., Death Star conference room). Another example event may be that the system 200 determined that the asset 1402 is not working (e.g., based on the data or lack thereof transmitted by the asset 1402). The statuses may reflect whether or not the issues have been resolved.

As discussed elsewhere herein, the dashboard 110 may receive the content depicted in the graphical user interfaces 1200, 1300, and 1400, from the utilization server 106 and/or data store 220, as discussed elsewhere herein, and provide the graphical user interface 1200 based on the retrieved content.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks (e.g., 104, 204, 214, etc.) using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOW), file transfer protocol (FTP), Web Socket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A computer-implemented method, comprising:
deploying a meter coupled to a private computer network, the meter capturing packet data sent or received by network nodes coupled to the private computer network, portions of the network nodes being associated with different physical spaces;
monitoring activity of the network nodes in association with the different physical spaces based on the captured packet data; and
determining, for a particular period of time, a utilization of a physical asset, which is located in a particular physical space of the different physical spaces, based on the monitored activity of a network node from the network nodes that represents the physical asset.

2. The computer-implemented method of claim 1, further comprising:
grouping, at the meter, the captured packet data according to the different physical spaces in which the network nodes that sent or received the packet data are located, wherein monitoring activity of the network nodes is further based on different groups with which the captured packet data are associated, the different groups representing the different physical spaces in which the network nodes are associated.

3. The computer-implemented method of claim 1, further comprising:
retrieving packet data reflecting the activity of the network nodes sending or receiving data during the particular period of time and associated with the particular physical space, the particular period of time reflecting a meeting conducted in the particular physical space;
generating a graphical meeting data visualization showing an asset topology for the particular physical space using the packet data reflecting activity of the network nodes during the particular period of time; and
displaying, on a display device to a stakeholder, the graphical meeting data visualization in a graphical user interface.

4. The computer-implemented method of claim 3, further comprising:
receiving, via an input device coupled to the display device, an input associated with a topological element of the graphical meeting data visualization;
retrieving packet data underlying the topological element; and
displaying a graphical element providing a description of the topological element in association with the topological element.

5. The computer-implemented method of claim 4, wherein the graphical element is an overlay overlaid over the topological element in the graphical user interface.

6. The computer-implemented method of claim 1, further comprising:
monitoring presence in the particular physical space based on motion packet data received from one or more motion sensors associated with the particular physical space, the motion packet data describing motion by one or more people located in the particular physical space, the captured packet data including the motion packet data, the network nodes including the one or more motion sensors, the particular period of time reflecting a meeting conducted in the particular physical space; and
determining one or more of an actual start time and an actual end time of the meeting conducted in the particular physical space based on the motion packet data.

7. The computer-implemented method of claim 6, further comprising:
processing the motion packet data received during the particular period of time to determine a number of people located in the particular physical space over the particular period of time and any change in the number of people in the particular physical space over the particular period of time; and
determining an attendance profile for the meeting using the number of people and the change in the number of people processed from the motion data.

8. The computer-implemented method of claim 6, further comprising:
performing a comparison between the actual start time and the actual end time of the meeting to a scheduled meeting duration associated with a stored meeting entry; and
determining a meeting efficiency score for the meeting based on the comparison.

9. A data packet processing meter comprising:
one or more computer processors;
one or more non-transitory memories;
a communication unit that sends and receives data via a controlled computer network;
a network data processor executable by the one or more computer processors to capture packet data sent or received by network nodes coupled to the controlled computer network, portions of the network nodes being associated with different physical spaces;
a utilization monitor executable by the one or more computer processors to monitor activity of the network nodes in association with the different physical spaces based on the captured packet data; and
a utilization logger executable by the one or more computer processors to log packet data reflecting the monitored activity of the network nodes by transmitting the packet data to a facility asset utilization monitor that determines, for a particular period of time based on the packet data, a utilization of a physical asset, which is located in a particular physical space of the different physical spaces, based on the monitored activity of a network node that represents the physical asset.

10. The data packet processing meter of claim 9, further comprising:
an asset filter executable by the one or more computer processors to group the captured packet data according to the different physical spaces in which the network nodes that sent or received the packet data are located, the facility asset utilization monitor receiving the captured packet data from one of the asset filter and the one or more non-transitory memories, the facility asset utilization monitor monitoring activity of the network nodes further based on different groups with which the captured packet data are associated, the different groups representing the different physical spaces in which the network nodes are associated.

11. A computer-implemented method, comprising:
deploying a meter in association with a gateway of a private computer network, the meter capturing packet data sent or received by network nodes coupled to the private computer network and located behind the gateway of the private computer network, a first portion of the network nodes being installed in association with a first physical space within a premises, and a second portion of the network nodes being installed in association with a second physical space within the premises;
capturing, at the meter, packet data exchanged by network nodes;
grouping, at the meter, the captured packet data received from the first portion of the network nodes with a first identifier uniquely identifying the first physical space;
grouping, at the meter, the captured packet data received from the second portion of the network nodes with a second identifier uniquely identifying the second physical space;
monitoring, at the meter, activity of the network nodes of the first portion in association with the first physical space based on the first portion of network nodes being grouped with the first identifier, and activity of the network nodes of the second portion in association with the second physical space based on the second portion of network nodes being grouped with the second identifier; and
logging, at a utilization server, the activity of the first portion of network nodes and the activity of the second portion of the network nodes.

12. The computer-implemented method of claim 11, further comprising:
processing the activity of the first portion of the network nodes and the activity of the second portion of the network nodes to determine a utilization profile of the first physical space and a utilization profile of the second physical space; and
generating a utilization recommendations for a stakeholder associated with the premises based on the utilization profile of the first physical space and the utilization profile of the second physical space.

13. A computing system, comprising:
one or more computer processors;
one or more non-transitory memories storing instructions that, when executed by the one or more computer processors, cause the computing system to perform operations comprising:
deploying a meter coupled to a private computer network, the meter capturing packet data sent or received by network nodes coupled to the private computer network, portions of the network nodes being associated with different physical spaces;
monitoring activity of the network nodes in association with the different physical spaces based on the captured packet data; and
determining, for a particular period of time, a utilization of a physical asset, which is located in a particular physical space of the different physical spaces, based on the monitored activity of a network node that represents the physical asset.

14. The computing system of claim 13, wherein the instructions, when executed by the one or more computer processors, further cause the computing system to perform operations comprising:
grouping, at the meter, the captured packet data according to the different physical spaces in which the network nodes that sent or received the packet data are located, wherein monitoring activity of the network nodes is further based on different groups with which the captured packet data are associated, the different groups representing the different physical spaces in which the network nodes are associated.

15. The computing system of claim 13, wherein the instructions, when executed by the one or more computer processors, further cause the computing system to perform operations comprising:
retrieving packet data reflecting the activity of the network nodes sending or receiving data during the particular period of time and associated with the particular physical space, the particular period of time reflecting a meeting conducted in the particular physical space;
generating a graphical meeting data visualization showing an asset topology for the particular physical space using the packet data reflecting activity of the network nodes during the particular period of time; and
displaying the graphical meeting data visualization in a graphical user interface.

16. The computing system of claim 15, wherein the instructions, when executed by the one or more computer processors, further cause the computing system to perform operations comprising:
receiving an input associated with a topological element of the graphical meeting data visualization;
retrieving packet data underlying the topological element; and
displaying a graphical element providing a description of the topological element in association with the topological element.

17. The computing system of claim 16, wherein the graphical element is an overlay overlaid over the topological element in the graphical user interface.

18. The computing system of claim 13, wherein the instructions, when executed by the one or more computer processors, further cause the computing system to perform operations comprising:
monitoring presence in the particular physical space based on motion packet data received from one or more motion sensors associated with the particular physical space, the motion packet data describing motion by one or more people located in the particular physical space, the captured packet data including the motion packet data, the network nodes including the one or more motion sensors, the particular period of time reflecting a meeting conducted in the particular physical space; and
determining one or more of an actual start time and an actual end time of the meeting conducted in the particular physical space based on the motion packet data.

19. The computing system of claim 18, wherein the instructions, when executed by the one or more computer processors, further cause the computing system to perform operations comprising:
processing the motion packet data received during the particular period of time to determine a number of people located in the particular physical space over the particular period of time and any change in the number of people in the particular physical space over the particular period of time; and
determining an attendance profile for the meeting using the number of people and the change in the number of people processed from the motion data.

20. The computing system of claim 18, wherein the instructions, when executed by the one or more computer processors, further cause the computing system to perform operations comprising:
performing a comparison between the actual start time and the actual end time of the meeting to a scheduled meeting duration associated with a stored meeting entry; and
determining a meeting efficiency score for the meeting based on the comparison.
